(19) United States
(12) Patent Application Publication
(10) Pub. No.: US 2026/0099755 A1
(43) Pub. Date: Apr. 9, 2026

(54) ARCHITECTURES FOR QUANTUM DATA CENTERS

(71) Applicant: Cisco Technology, Inc., San Jose, CA (US)

(72) Inventors: Hassan Shapourian, San Mateo, CA (US); Jiapeng Zhao, Kenmore, WA (US); Reza Nejabati, Los Angeles, CA (US); Ramana Rao V R Kompella, Foster City, CA (US)

(21) Appl. No.: 18/928,343

(22) Filed: Oct. 28, 2024

Related U.S. Application Data
(60) Provisional application No. 63/653,573, filed on May 30, 2024.

(51) Int. Cl. G06N 10/80; G06N 10/20

(52) U.S. Cl. CPC G06N 10/80; G06N 10/20

(57) ABSTRACT

In some aspects, the techniques described herein relate to an apparatus including: a plurality of quantum processing units arranged within a rack; and a top-of-rack switch configured to: interconnect the plurality of quantum processing units using a near infrared optical link, and connect to a quantum network switch using a telecommunication wavelength link.

### CROSS-REFERENCE TO RELATED APPLICATION

This application claims priority to U.S. Provisional Application No. 63/653,573, filed May 30, 2024, the entirety of which is incorporated herein by reference.

### TECHNICAL FIELD

The present disclosure relates to quantum interconnects between quantum devices within a data center.

### BACKGROUND

Quantum advantage in quantum computing is generally achieved at scale when the number of qubits is on the order of one million. On the other hand, the number of qubits in a monolithic processor (i.e., a single quantum chip) is generally limited across quantum computing technologies. Hence, to realize a scalable quantum computer, several quantum processors may need to be connected. Quantum networks are the enabling technology for connecting small-scale quantum processors. Beyond that, quantum networks can be used to connect various quantum devices, such as quantum sensors or clocks, for improved precision and synchronization. Such networks also enable quantum safe cryptographic solutions by leveraging quantum key distribution protocols.

### BRIEF DESCRIPTION OF THE DRAWINGS

FIG. 1 is a roadmap for developing a quantum data center, according to an example embodiment.

FIG. 2 is a high-level quantum data center architecture, according to an example embodiment.

FIG. 3 illustrates a quantum-enabled optical switch, according to an example embodiment.

FIG. 4 illustrates an example of a quantum enabled Top-of-Rack (ToR) switch, according to an example embodiment.

FIG. 5 illustrates a Clos network implemented using quantum ToR switches, according to an example embodiment.

FIG. 6 illustrates a tree network implemented using quantum ToR switches, according to an example embodiment.

FIG. 7 illustrates a fat tree network implemented using quantum ToR switches, according to an example embodiment.

FIG. 8A illustrates a first protocol for distributing entanglement between quantum processing units arranged on the same rack associated with the same ToR switch, according to an example embodiment.

FIG. 8B illustrates a second protocol for distributing entanglement between quantum processing units arranged on the same rack associated with the same ToR switch, according to an example embodiment.

FIG. 9 illustrates a protocol for distributing entanglement between quantum processing units arranged on different racks associated with different ToR switches, according to an example embodiment.

FIG. 10 illustrates a detailed view of a protocol for distributing entanglement between quantum processing units arranged on different racks associated with different ToR switches, according to an example embodiment.

FIG. 11 illustrates a first example communication qubit of a quantum processing unit, according to an example embodiment.

FIG. 12 illustrates a second example communication qubit of a quantum processing unit, according to an example embodiment.

FIG. 13 illustrates a third example communication qubit of a quantum processing unit, according to an example embodiment.

FIG. 14 illustrates a fourth example communication qubit of a quantum processing unit, according to an example embodiment.

FIG. 15 illustrates a first protocol for distributing entanglement between quantum processing units arranged on different racks associated with different ToR switches that uses the communication qubits (e.g., quantum memories) of the quantum processing units, according to an example embodiment.

FIG. 16 illustrates a second protocol for distributing entanglement between quantum processing units arranged on different racks associated with different ToR switches that uses the communication qubits (e.g., quantum memories) of the quantum processing units, according to an example embodiment.

FIG. 17A illustrates the functional operation of a quantum buffer, according to an example embodiment.

FIG. 17B illustrates a generalized structure for a quantum buffer, according to an example embodiment.

FIGS. 18A and 18B illustrate a protocol utilizing a single quantum buffer to distribute entanglement between quantum processing units arranged on different racks associated with different ToR switches, according to an example embodiment.

FIG. 19 illustrates a protocol utilizing two quantum buffers to distribute entanglement between quantum processing units associated with different ToR switches, according to an example embodiment.

FIG. 20 illustrates a first protocol for distributing entanglement throughout a Clos network, according to an example embodiment.

FIG. 21, illustrates the creation of network paths through a Clos network to distribute entanglement through the Clos network, according to an example embodiment.

FIG. 22 illustrates a second protocol for distributing entanglement throughout a Clos network, according to an example embodiment.

FIG. 23 illustrates a third protocol for distributing entanglement throughout a Clos network, according to an example embodiment.

FIG. 24 illustrates a plurality of network topologies throughout which protocols of the disclosed techniques may be used to distribute entanglement, according to example embodiments.

FIG. 25 illustrates a protocol for distributing entanglement in a D-Cell network, according to an example embodiment.

FIG. 26 is an abstract illustration of a partial BCube quantum network in which quantum processing units act as repeaters for distributing entanglement throughout the network, according to an example embodiment.

FIG. 27 illustrates a protocol for distributing entanglement throughout a simple partial BCube network using quantum processing units as repeaters, according to an example embodiment.

FIG. 28 illustrates a complex partial BCube network that utilizes quantum processing units as repeaters to distribute entanglement throughout the network, according to an example embodiment.

FIG. 29 illustrates a full BCube network that utilizes quantum processing units as repeaters to distribute entanglement throughout the network, according to an example embodiment.

FIG. 30 illustrates a linear network that utilizes quantum processing units as repeaters to distribute entanglement throughout the network, according to an example embodiment.

FIG. 31 illustrates a two-dimensional network that utilizes quantum processing units as repeaters to distribute entanglement throughout the network, according to an example embodiment.

FIG. 32 illustrates a circuit decomposition for parallel entanglement distribution, according to an example embodiment.

FIG. 33 illustrates a protocol for parallel entanglement distribution in a Clos network, according to an example embodiment.

FIG. 34 is a flowchart providing a generalized process flow for distributing entanglement between two quantum processing units arranged within a quantum network, according to an example embodiment.

FIG. 35 illustrates a hardware block diagram of a device configured to implement one or more aspects of the quantum data center architecture techniques disclosed herein, according to an example embodiment.

### DETAILED DESCRIPTION

### Overview

Provided for herein are modular quantum data center systems that provide for quantum data center architectures. A repeatable node of the architectures includes a plurality of communication qubits that are connected to a “top-of-rack” optical switch that includes one or more entanglement sources and Bell state measurement devices. The switch can interconnect the local entanglement sources using infrared or telecommunication wavelengths and connect to other nodes using telecommunication wavelengths. These repeatable nodes can implement a number of different entanglement generation protocols and can be implemented in a number of different network topologies. Accordingly, provided for herein are architectures for quantum networks which include designs for quantum-enabled optical switches, protocols to generate end-to-end entanglement, routing across the network, and other aspects of architecture used to implement quantum data centers.

Accordingly, in some aspects, the techniques described herein relate to an apparatus including: a plurality of quantum processing units arranged within a rack; and a top-of-rack switch configured to: interconnect the plurality of quantum processing units using a near infrared optical link, and connect to a quantum network switch using a telecommunication wavelength link.

In some other aspects, the techniques described herein relate to a system including: a first top-of-rack switch configured to interconnect a first plurality of quantum processing units arranged within a first rack using a first near infrared optical link; a second top-of-rack switch configured to interconnect a second plurality of quantum processing units arranged within a second rack using a second near infrared optical link; and a telecommunication wavelength network link forming a quantum network between the first top-of-rack switch and the second top-of-rack switch.

In still other aspects, the techniques described herein relate to a method including: generating an entangled photon pair at a top-of-rack switch associated with a plurality of quantum processing units arranged within a rack; providing a telecommunication wavelength photon of the entangled photon pair to a Bell state measurement device arranged at a switch within a quantum network; providing a near infrared wavelength photon of the entangled photon pair to a quantum processing unit of the plurality of quantum processing units; and obtaining a signal at the top-of-rack switch indicating that entanglement has been distributed between the quantum processing unit of the plurality of quantum processing units and a quantum processing unit arranged outside the rack in response to a measurement performed on the telecommunication wavelength photon at the Bell state measurement device.

### Example Embodiments

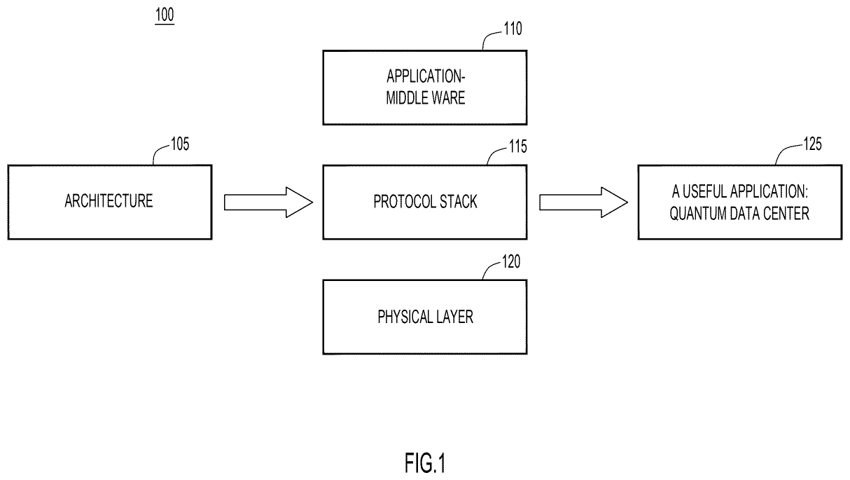

Illustrated in FIG. 1 is a roadmap 100 for developing a quantum data center. As illustrated, an architecture 105 is developed, which supports application middleware 110, a protocol stack 115 and a physical layer 120, the combination of which provides for a useful quantum data center 125. The techniques provided for herein result in such a useful quantum data center.

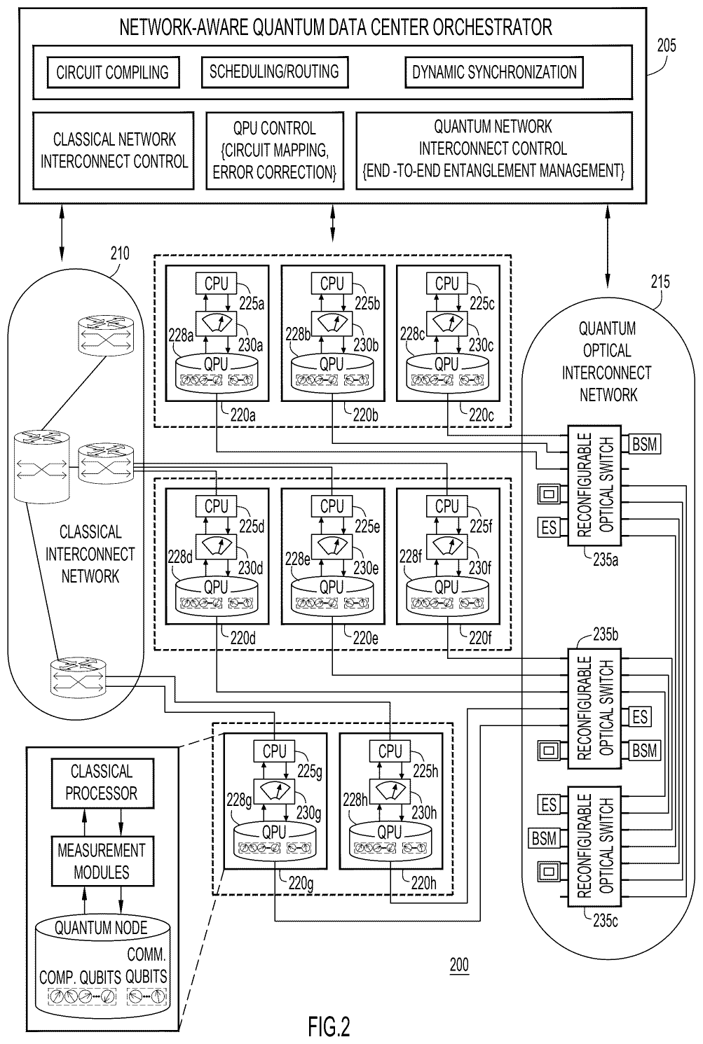

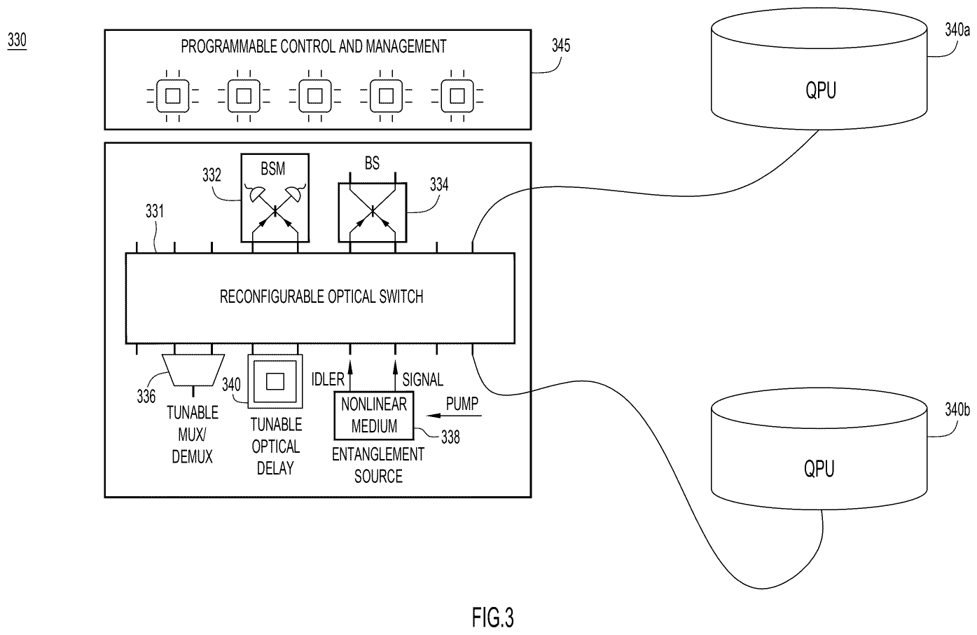

Turning to FIG. 2, illustrated therein is a high-level quantum data center architecture 200, according to the disclosed techniques. The architecture includes a network-aware quantum data center orchestrator 205 that provides for circuit compiling, scheduling/routing and data synchronization. The architecture includes a classical (i.e., non-quantum) interconnect network 210 and a quantum optical interconnect network 215. Also included in the architecture are quantum nodes 220a, 220b, 220c, 220d, 220e, 220f, 220g, and 220h, each of which also includes a respective classical processor 225a, 225b, 225c, 225d, 225e, 225f, 225g, and 225h, a respective quantum processor 228a, 228b, 228c, 228d, 228e, 228f, 228g, and 228h, and a respective measurement module 230a, 230b, 230c, 230d, 230e, 230f, 230g, and 230h. The quantum optical interconnect network includes a number of quantum-enabled optical switches 235a, 235b, and 235c, which are illustrated in more detail in FIG. 3.

Illustrated in FIG. 3 is a quantum enabled switch 330, which includes a reconfigurable switch 331 that provides for switching between multiple quantum devices, such as Bell state measurement device 332, beam splitter 334, multiplexers/demultiplexers 336, entanglement source 338 and tunable delay line 340. Entanglement source 338 may be embodied as a probabilistic entanglement source based on, for example, spontaneous down conversion (SPDC) or spontaneous four-wave mixing (SFWM). Entanglement generated from such devices may be simulated as a Poisson process with an average emission rate of R_{gen}. As understood by the skilled artisan, the value of R_{gen} may be on the order of 10⁶ ebit/sec. Reconfigurable switch 331 provides interconnections between quantum processing unit 340a and quantum processing unit 340b.

Other quantum enabled devices may also be incorporated into the quantum-enabled optical switches, as may classical devices where appropriate. As also illustrated in FIG. 3, the quantum-enabled optical switch 331 also includes programmable control and measurement functions 345.

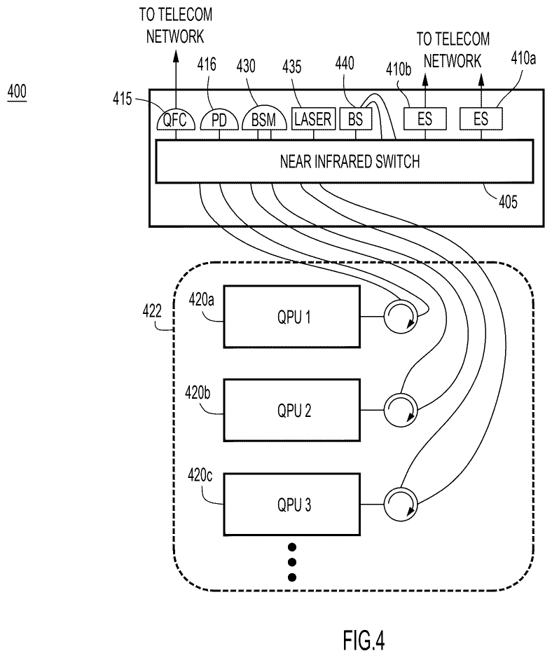

With reference to FIG. 4, depicted therein is a specific example of a quantum enabled switch 400 configured to operate as a quantum top-of-rack or quantum ToR switch. As illustrated in FIG. 4, the quantum ToR switch 400 uses an optical switch 405, which operates at near infrared wavelengths, to communicate between the quantum processing units 420a, 420b and 420c of the same rack 422 and one or more entanglement sources 410a and 410b. Entanglement sources 410a and 410b may generate entangled photons in near infrared wavelengths (750-1200 nm) for use within ToR switch 400 or at telecommunication wavelengths (e.g., 1260-1675 nm) for generating entanglement between quantum processing units arranged on different racks associated with different ToR switches. In order to switch between the near infrared wavelengths and the telecommunication wavelengths, ToR switch 400 includes a quantum frequency converter 415 which can convert a near infrared wavelength quantum signal to a telecommunications wavelength quantum signal, and vice versa. Accordingly, when quantum signals are sent between quantum processing units 420a-c, the quantum signals are switched between quantum processing units 420a-c using near-infrared optical switch 405 and the quantum signals remain signals in near infrared wavelengths and their associated frequencies.

When a quantum signal is destined for another ToR switch 400, or a quantum processing unit arranged within another ToR switch, quantum frequency converter 415 may be used to convert a near infrared wavelength quantum signal to a telecommunications wavelength signal without loss of the quantum states and entanglements associated with the signal. For example, quantum frequency converter 415 may be a quantum frequency converter that makes use of a non-linear medium that transfers the quantum states of a first signal to a second signal of a different wavelength and frequency. According to certain examples, a strong pump laser interacts with the input photon in the nonlinear medium of the quantum frequency converter, causing a process called three-wave mixing. This process shifts the photon's frequency to a new value, while preserving its quantum properties, such as coherence and entanglement. Such conversion may be wavelength/frequency specific.

Different quantum frequency conversions may require different non-linear mediums. Accordingly, ToR switch 400 may be configured with multiple quantum frequency converters 415. For example, a first quantum frequency converter 415 may be used to convert incoming signals from a telecommunication wavelength to a near infrared wavelength and a second quantum frequency converter may be used to convert an outgoing signal from a near infrared wavelength to a telecommunication wavelength. As multiple telecommunication and near infrared wavelengths may be used. ToR switch 400 may be equipped with a large number of quantum frequency converters for respective telecommunication-to-near infrared wavelength conversions and respective near infrared-to-telecommunication wavelength conversions.

Also included in ToR switch 400 are a photon detector 416, a Bell state measurement device 430, a laser source 435, and a beam splitter 440.

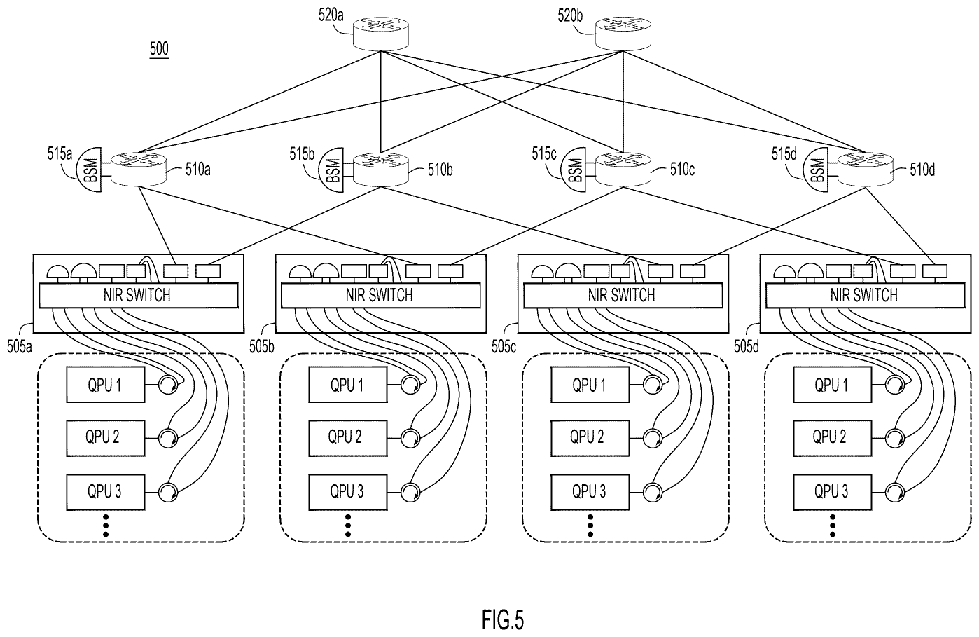

ToR switch 400 may be used to implement a number of different network topologies, such as the Clos network 500 illustrated in FIG. 5. A Clos network topology is a type of multistage switching network designed to provide scalable, non-blocking communication between a large number of input and output ports. Named after Charles Clos, who introduced the concept in 1952, this topology is commonly used in telecommunications, data centers, and high-performance computing due to its efficiency and ability to support high bandwidth. Clos network 500 includes a plurality of quantum ToR switches 505a, 505b, 505c, and 505d which serve as the input/output stage of Clos network 500. The middle stage includes switches 510a, 510b, 510c, and 510d, each of which includes a respective Bell state measurement device 515a, 515b, 515c and 515d, and switches 520a and 520b which interconnect switches 510a-d. Switches 510a-d and 520a and 520b may be configured to operate at telecommunication wavelengths because they send signals between quantum ToR switches 505a-d. Bell state measurement devices 515a-d allow for entanglement swapping to be performed between switches 510a-d, as will be explained below.

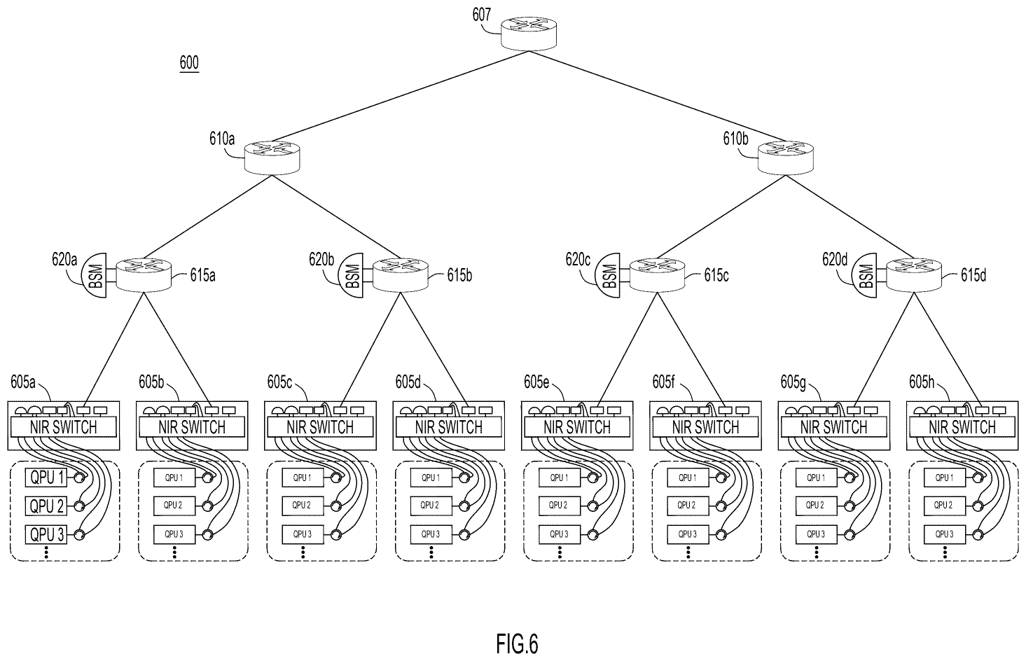

Turning to FIG. 6, depicted therein is network 600 configured as a tree network topology. A tree network topology is a hierarchical structure resembling an inverted tree with branches spreading out from a central root node. This topology is commonly used in large networks, such as enterprise networks and the Internet, where a hierarchical organization of devices is beneficial. Tree network 600 includes quantum ToR switches 605a, 605b, 605c, 605d, 605e, 605f, 605g and 605h, which are interconnected using root node switch 607 and intermediate nodes 610a, 610b, 615a, 615b, 615c and 615d. Root node switch 607 and intermediate nodes 610a/b and 615a-d may be configured to operate using telecommunication wavelengths. Intermediate nodes 615a-d include respective Bell state measurement devices 620a, 620b, 620c and 620d, which allow entanglement swapping between the nodes of tree network 600.

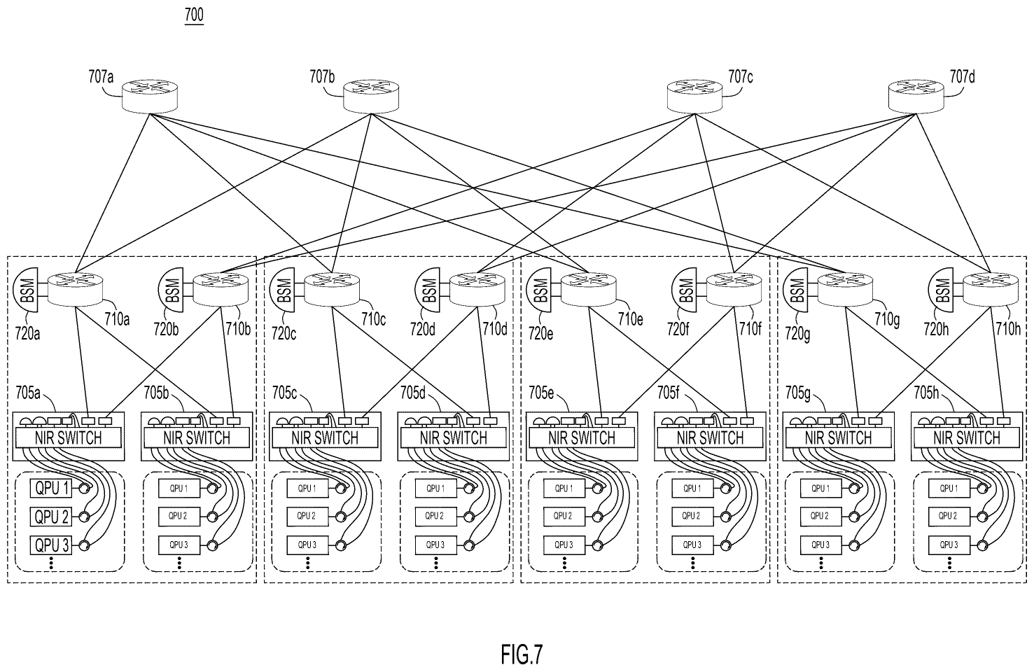

FIG. 7 illustrates a fat tree network 700, which is similar to tree network 600 of FIG. 6. Fat tree network 700, however, includes a plurality of root node switches 707a, 707b, 707c, and 707d. Quantum ToR switches 705a, 705b, 705c, 705d, 705e, 705f, 705g and 705h and intermediate nodes 710a, 710b, 710c, 710d, 710e, 710f, 710g and 710h have a similar structure to those of quantum ToR switches 605a-h and intermediate nodes 620a-d of FIG. 6, respectively. Accordingly, root nodes 707a-d and intermediate nodes 710a-h may be configured to operate at telecommunication wavelengths and intermediate nodes 710a-h may be configured with Bell state measurement devices 720a, 720b, 720c, 720d, 720e, 720f, 720g and 720h to perform entanglement swapping between the elements of fat tree network 700.

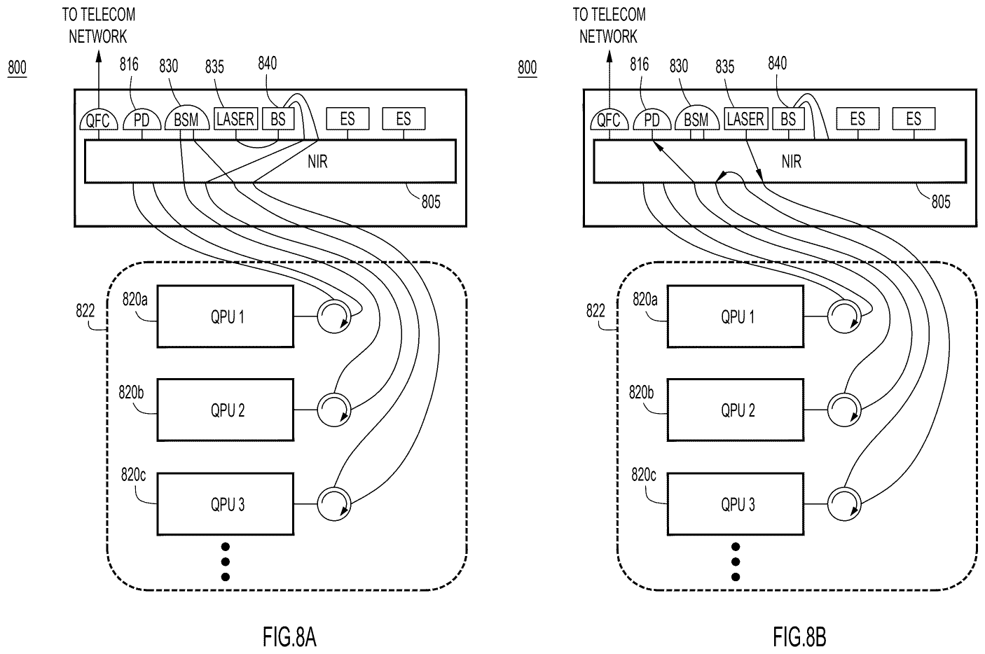

Turning to FIG. 8A, depicted therein is a ToR switch 800 configured according to the disclosed techniques, which will be used to describe a protocol to entangle an ebit, a two-party quantum state, between two of the quantum processing units 820a, 820b, 820c arranged within rack 822 associated with ToR switch 800. As illustrated in FIG. 8A, an ebit is to be entangled between quantum processing unit 820b and quantum processing unit 820c. Reconfigurable near infrared optical switch 805 provides connections such that quantum processing units 820b and 820c are operated as emitters and are pulse driven by laser source 835 via beam splitter 840 such that they direct photons to Bell state measurement device 830. Specifically, the output ports of quantum processing units 820b and 820c are attached to Bell state measurement device 830. The input ports of quantum processing units 820b and 820c are connected to the output of beam splitter 840 which splits coherent pulses coming from the laser source 835 and excites the respective communication qubits of quantum processing unit 820b and 820c coherently. A single photon detection event at Bell state measurement device 830 heralds an entanglement generation between the quantum processing units 820b and 820c.

FIG. 8B illustrates an alternative entanglement generation protocol implemented via ToR switch 800, where the communication qubit of quantum processing unit 820c emits a photonic qubit as a result of excitation by the laser source 835. Connections provided by reconfigurable near infrared optical switch 805 direct the generated photon towards the quantum processing unit 820c for a scattering event. The results of the scattering event are directed to the photon detector 816, where a detection heralds a successful entanglement generation.

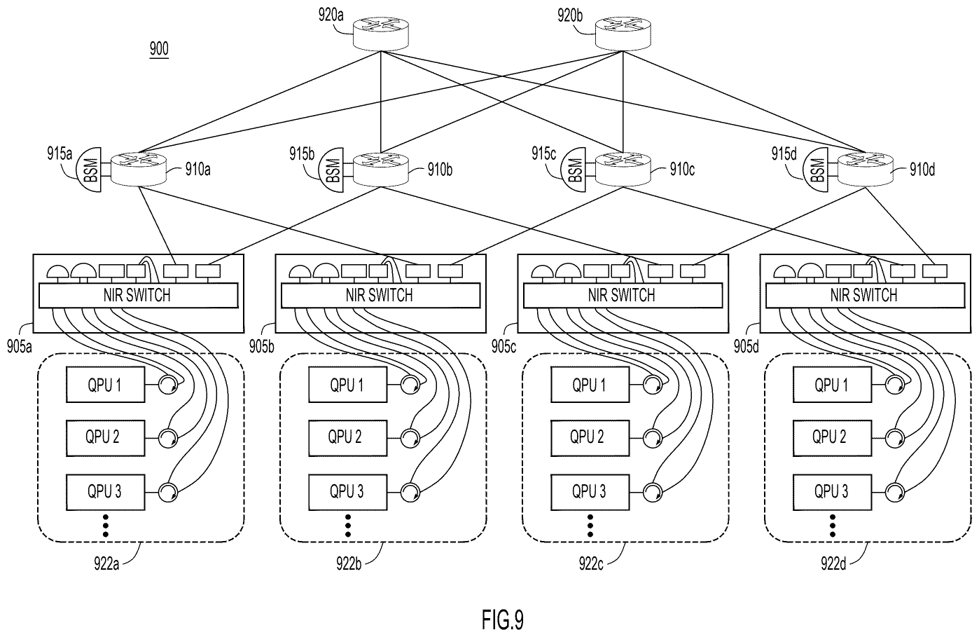

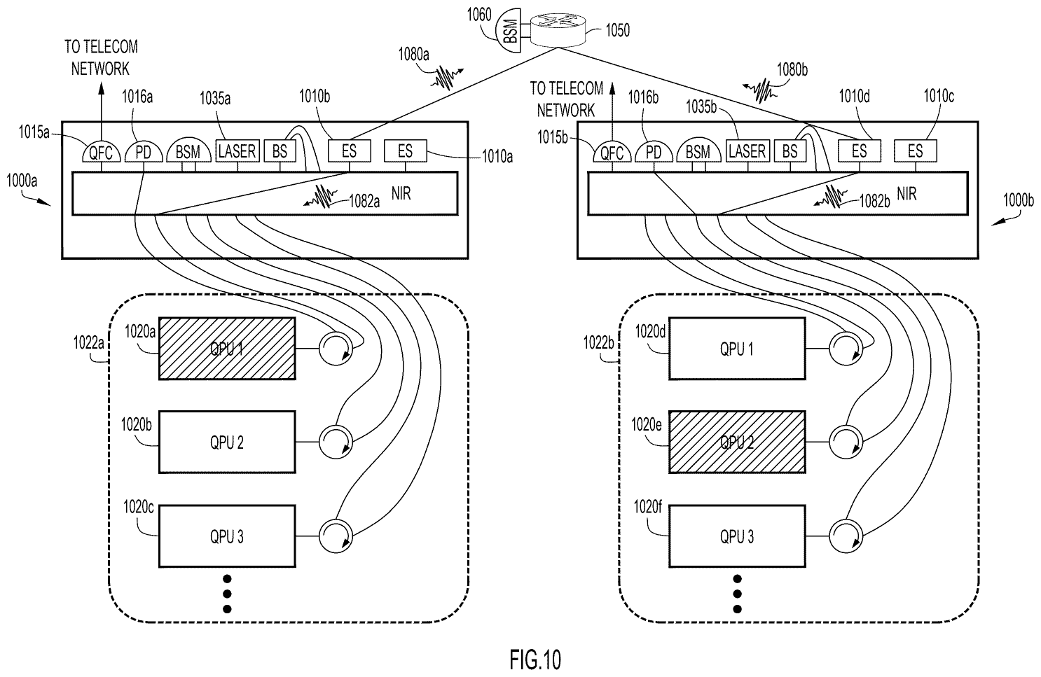

Turning to FIGS. 9 and 10, depicted therein is a configuration of quantum-enabled optical switches to implement an entanglement generation protocol between quantum processing units on different racks. Depicted in FIG. 9 is a Clos network topology 900 configured to generate entanglement between quantum processing units arranged on different ones of racks 922a, 922b, 922c and/or 922d associated with quantum ToR switches 905a, 905b, 905c and 905d, respectively. Accordingly, Clos network topology 900 is configured similarly to the topology of Clos network 500 of FIG. 5 with middle stage switches 910a, 910b, 910c and 910d, each of which includes a respective Bell state measurement device 915a, 915b, 915c and 915d, and with switches 920a and 920b which interconnect switches 910a-d. As described in detail with reference to FIG. 10, the Bell state measurement devices 915a-d allow for entanglement to be generated between the quantum processing units arranged within the racks 922a-d associated with quantum ToR switches 905a-d.

As illustrated in FIG. 10, quantum processing units 1020a, 1020b and 1020c are arranged on rack 1022a associated with ToR switch 1000a and quantum processing units 1020d, 1020e and 1020f are arranged on rack 1022b associated with ToR switch 1000b. Entanglement source 1010b of quantum ToR switch 1000a and entanglement source 1010d of quantum ToR switch 1000b are attached to Bell state measurement device 1060 of intermediate switch 1050. The entanglement sources 1010b and 1010d, as well as entanglement sources 1010a and 1010c, may be embodied as spontaneous parametric down-conversion sources, though other types of sources may be used without deviating from the disclosed techniques, such as spontaneous four-wave mixing sources.

As illustrated in FIG. 10, a telecommunication wavelength idler photon 1080a of an entangle photon pair is provided to Bell state measurement device 1060 of intermediate switch 1050 from entanglement source 1010b of ToR switch 1000a. The other photon of this entangled pair is a near infrared wavelength signal photon 1082a, which is provided to the quantum processing unit 1020a. Similarly, a telecommunication wavelength idler photon 1080b of an entangled photon pair is provided to Bell state measurement device 1060 of intermediate switch 1050 from entanglement source 1010d of ToR switch 1000b. The other photon of this entangled pair is near infrared signal photon 1082b, which is provided to the quantum processing unit 1020e. In other words, the signal photons 1082a and 1082b remain at the rack 1022a/b of the ToR switch 100a/b on which they were created, while the idler photons 1080a and 1080b are sent to a Bell state measurement device 1060 of intermediate switch 1050.

The signal photons 1082a and 1082b are directed towards the communication qubits (e.g., quantum memories) inside quantum processing units 1020a and 1020e, respectively. The states of the signal photons 1082a and 1082b are transferred to communication qubits of quantum processing units 1020a and 1020e, which is heralded by a scattering process. The signal photons 1082a and 1082b are then provided to single photon detectors 1016a and 1016b, respectively, where they are measured.

Inside Bell state measurement device 1060, the idler photons 1080a and 1080b are sent to a set of beam splitters and the outputs are sent to a set of single-photon detectors contained within Bell state measurement device 1060. The measurement made in single photon detector 1016a, single photon detector 1016b, and the single photon detectors of Bell state measurement device 1060 results in an entanglement swap which generates entanglement between the communication qubits of quantum processing units 1020a and 1020e.

In order for the processes described above to be successful, idler photons 1080a and 1080b should arrive at Bell state measurement device 1060 at the same time, even though they may be randomly generated, and therefore, may not be generated at the same time.

According to some examples of the disclosed techniques, a “brute force” algorithm may be utilized to have idler photon 1080a and idler photon 1080b arrive at Bell state measurement device 1060 at the same time. According to such a brute force algorithm, entanglement source 1010a and entanglement source 1010d (and/or entanglement source 1010b and entanglement source 1010c) are run over a timeslot until Bell state measurement device 1060 detects a coincident event. More specifically, each time entanglement source 1010a and entanglement source 1010d generate a signal photon and an idler photon there is a heralding event from single photon detector 1016a or single photon detector 1016b, respectively. If the idler photons from entanglement source 1010a and entanglement source 1010d arrive at Bell state measurement device 1060 at substantially the same time, a successful entanglement event is determined. If the idler photons from entanglement source 1010a and entanglement source 1010d arrive at Bell state measurement device 1060 at sufficiently different times, the communication qubits in quantum processing unit 1020a from the corresponding signal photon is reset, as are the quantum states stored in quantum processing unit 1020e. This process is repeated until the idler photons arrive at Bell state measurement device 1060 concurrently.

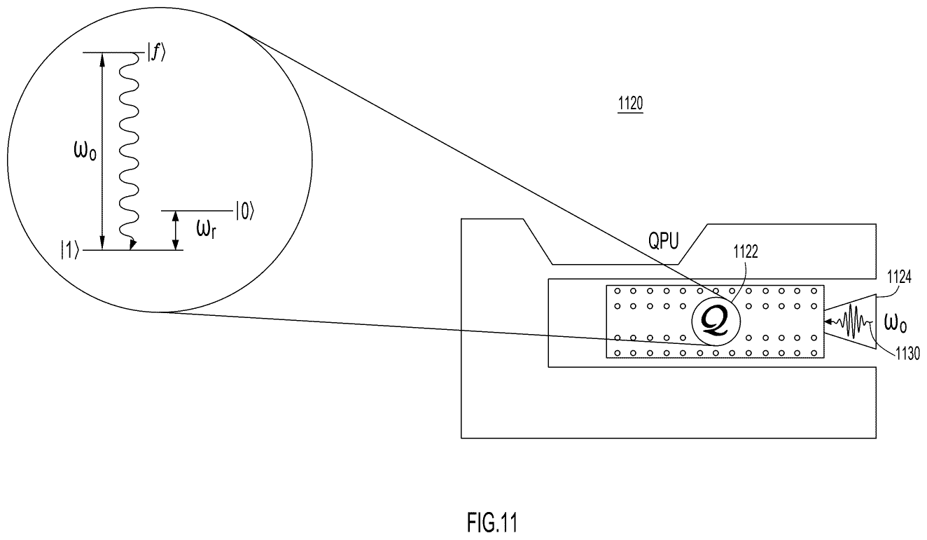

According to other examples of the disclosed techniques, ToR switches 1000a and 1000b may be configured to ensure the simultaneous arrival of idler photons 1080a and 1080b at Bell state measurement device 1060. Some of these techniques make use of the functionality of the quantum memories and/or communication qubits contained within quantum processing units 1020a-f. Accordingly, examples of communication qubits will now be described with reference to FIGS. 11-14.

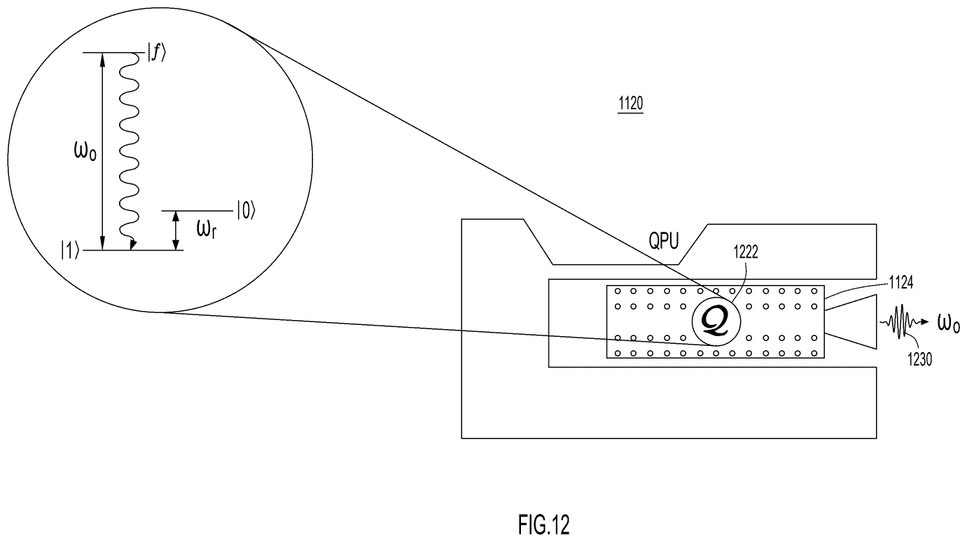

As illustrated in FIG. 11, communication qubit 1122 includes a multi-level quantum system 1120 with a photonic interface 1124. An incoming photonic qubit 1130 enters into photonic interface 1124 and its quantum states are transferred to communication qubit 1122. Communication qubit 1122 can run as a heralded quantum memory (i.e., a single-photon scattering center) to swap states with an incoming photonic qubit 1130. As illustrated in FIG. 12, communication qubit 1222 may operate as a deterministic spin-photon gate in which photon 1230 is a scattered photon that is captured at the output of photonic interface 1124, or as a probabilistic spin-photon projected in which the output of photonic interface 1124 captures photon 1230 as a reflected photon.

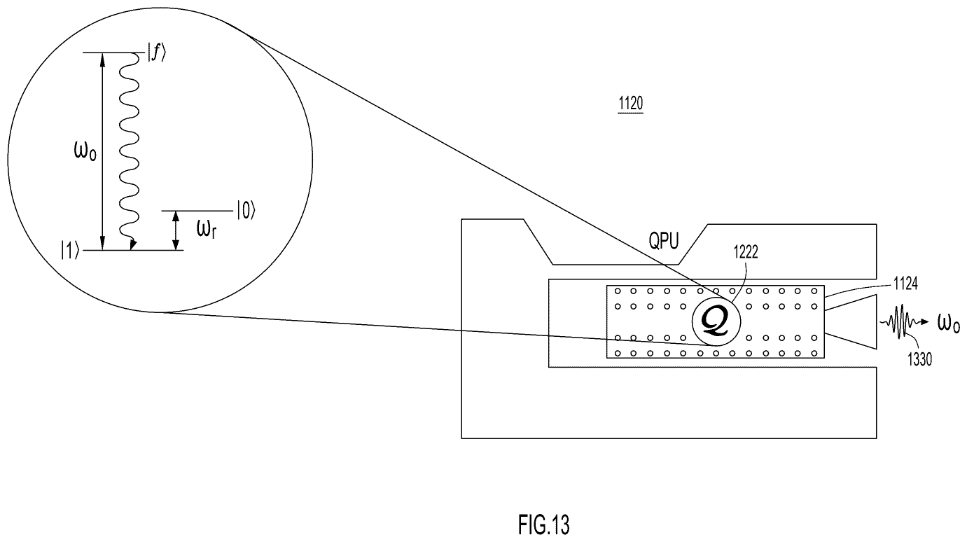

Communication qubit 1122 may also run as a single-photon emitter, as shown in FIG. 13, to generate an entangled state with an outgoing photonic qubit 1330.

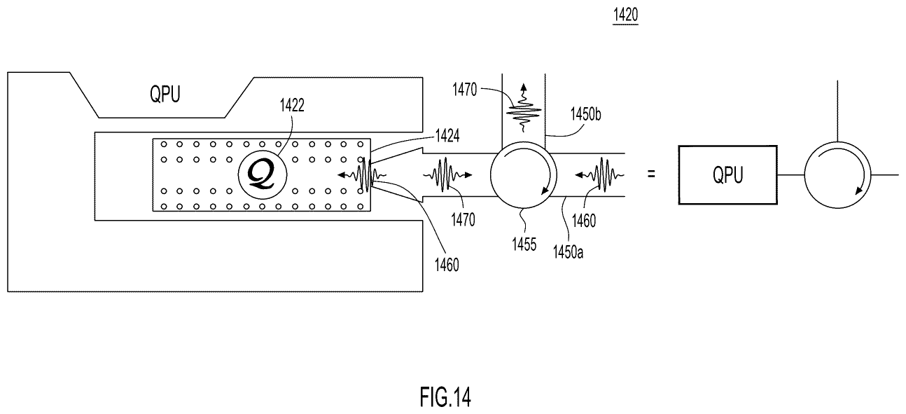

FIG. 14 illustrates a model abstraction of a quantum processing unit 1420, including a photonic interface 1424, equipped with a plurality of communication qubits 1422 connected to optical fibers 1450a and 1450b and a circulator 1455 to split the incoming signals 1460 and outgoing signals 1470.

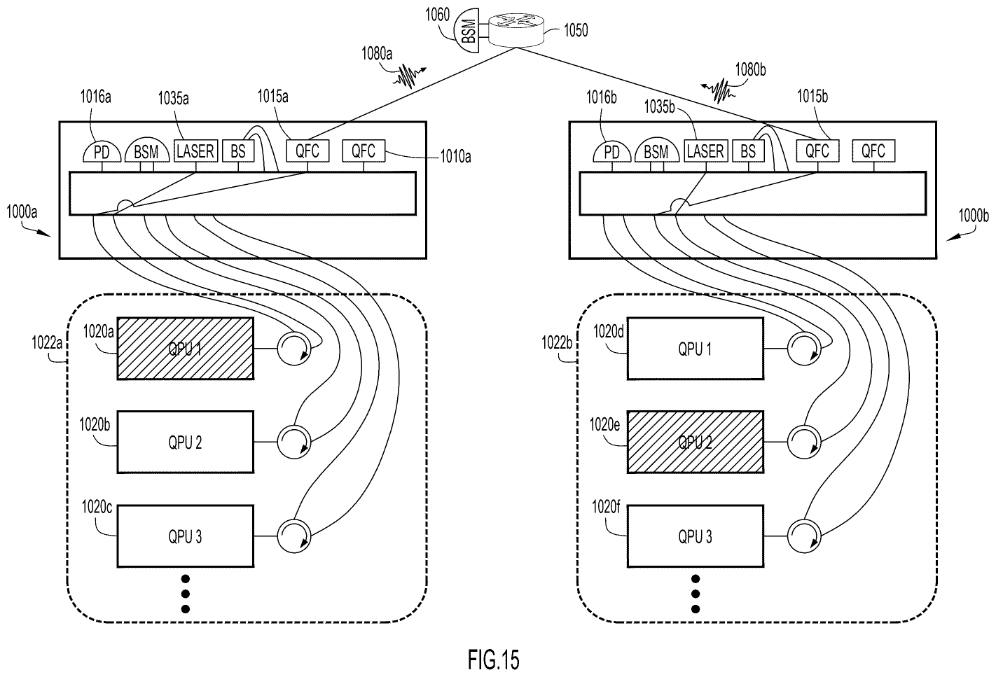

Turning to FIG. 15, a protocol which uses communication qubits, like those illustrated in FIGS. 11-14, will now be described with reference to FIG. 15. In FIG. 15, laser source 1035a and laser source 1035b are used to respectively drive the communication qubits of quantum processing units 1020a and 1020e to operate as emitters. The outputs of quantum processing units 1020a and 1020e are connected to quantum frequency converters 1015a and 1015b, respectively, which convert the emitted photons to telecommunication wavelength photons from the infrared wavelengths at which they were emitted from quantum processing units 1020a and 1020e. The telecommunication wavelength photons are provided to Bell state measurement device 1060 of intermediate switch 1050. Bell state measurement device 1060 performs an entanglement swap on the telecommunication wavelength photons which generates entanglement between the photons stored in the communication qubits of quantum processing units 1020a and 1020e.

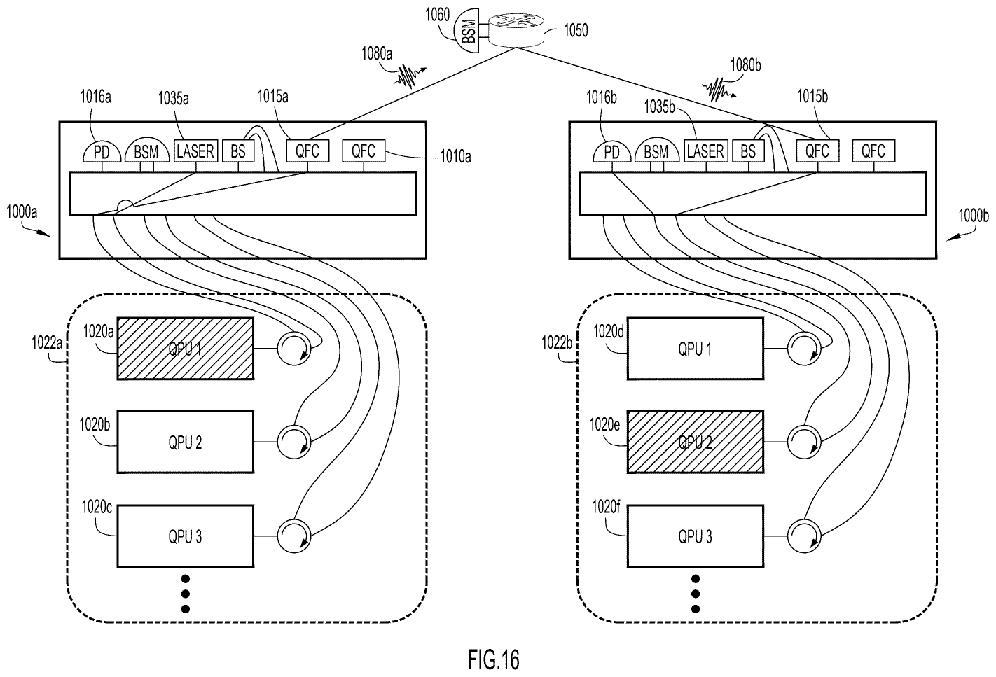

With reference now made to FIG. 16, another example protocol which uses communication qubits, like those illustrated in FIGS. 11-14, will now be described. In FIG. 16, laser source 1035a drives the communication qubit of quantum processing unit 1020a as an emitter. The output of quantum processing unit 1020a is connected to quantum frequency converter 1015a, which converts the emitted photon to a telecommunication wavelength idler photon 1080a from the infrared wavelength at which it was emitted from quantum processing unit 1020a. The telecommunication wavelength photon is provided to Bell state measurement device 1060 of intermediate switch 1050. Quantum processing unit 1020e, on the other hand, is operated as a scattering point. The reflected photon is directed to single photon detector 1016b as the heralding signal, while the other photon is directed to quantum frequency converter 1015b, which converts the emitted photon to a telecommunication wavelength idler photon 1080b. The telecommunication wavelength idler photon 1080b is provided to Bell state measurement device 1060. Bell state measurement device 1060 performs an entanglement swap on the telecommunication wavelength photons which generates entanglement between the quantum memories of quantum processing units 1020a and 1020e.

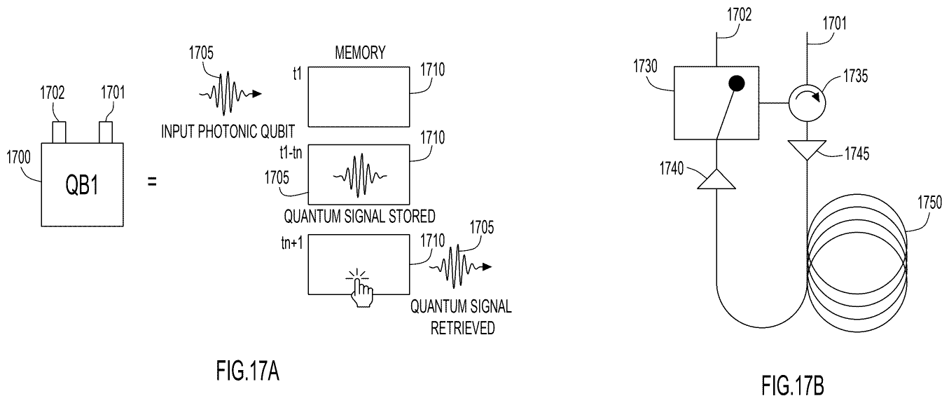

The above described “brute force” algorithm and the quantum communication qubit algorithms of FIGS. 15 and 16 are examples of how to address synchronization. Additional techniques may address synchronization using a quantum buffer, an example of which is illustrated in FIGS. 17A and 17B. FIG. 17A illustrates the functional operation of quantum buffer 1700. Specifically, quantum buffer 1700 stores a quantum signal received via input 1701 without requiring a heralding signal. As illustrated, a photonic qubit 1705 enters a memory 1710 of the quantum buffer 1700 at time t1 via input 1701 and is stored there for a time t1 to tn. At time tn+1, the photonic qubit is released from quantum buffer 1700 via output 1702. FIG. 17B illustrates a generalized structure for a quantum buffer that includes a switch 1730, a circulator 1735, and optical delay line 1750. When switch 1730 is connected between port 1740 and circulator 1735, a photonic qubit will continually circulate within optical delay line 1750, exiting circulator 1735 via port 1745. When switch 1730 is actuated to connect port 1740 to output 1702, the photonic qubit is released from the quantum buffer. Accordingly, quantum buffer 1700 can release qubits at multiples of the time it takes the qubit to traverse optical delay line 1750. Such quantum buffers may be used to synchronize obtaining photon qubits at a Bell state measurement device in quantum entanglement distribution protocols.

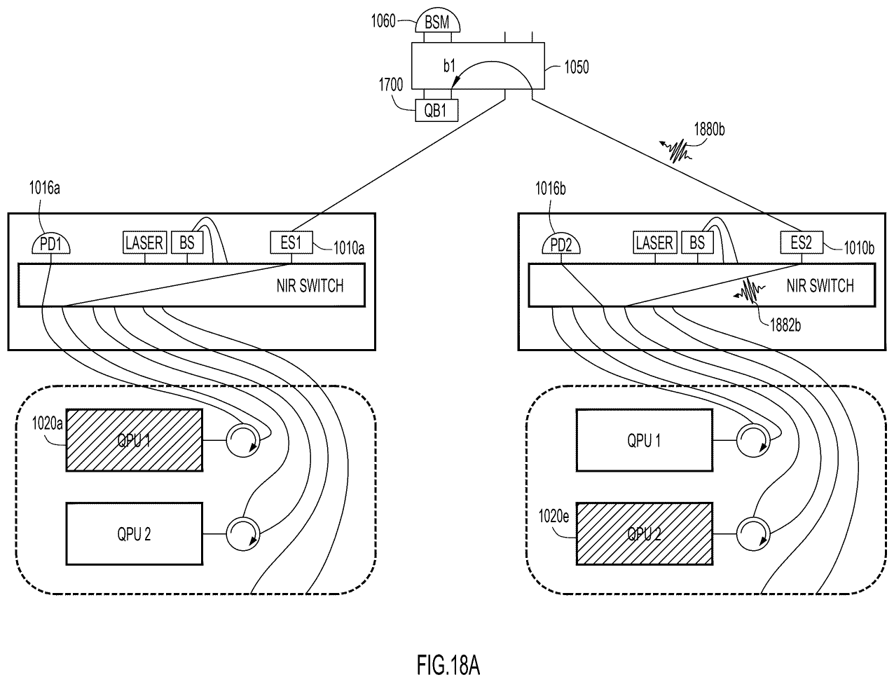

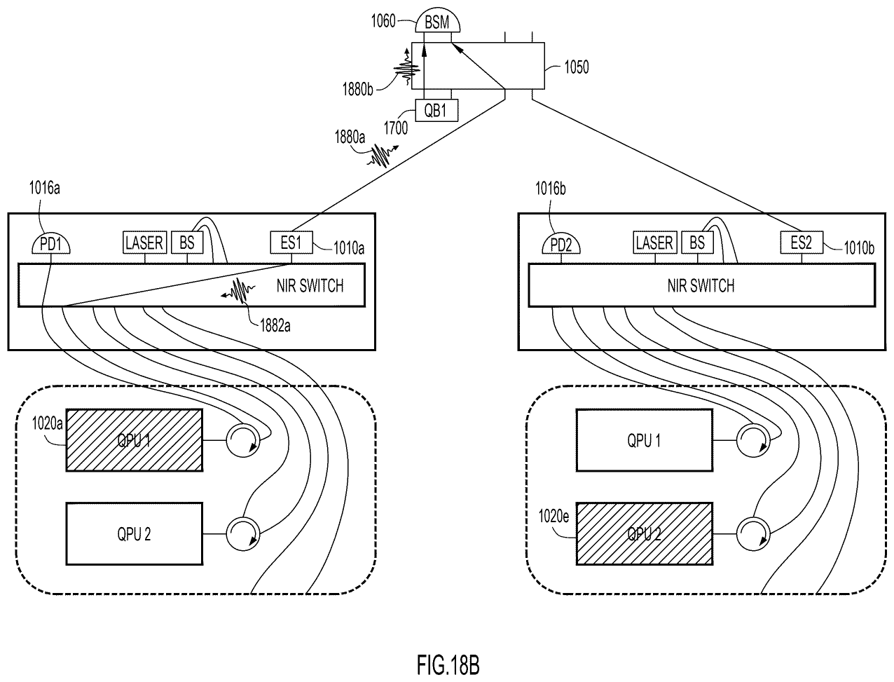

With reference now made to FIGS. 18A and 18B, depicted therein is a protocol for distributing quantum entanglement through a network using a quantum buffer. As illustrated in FIGS. 18A and 18B, intermediate switch 1050 is configured with a single quantum buffer 1700 in addition to Bell state measurement device 1060. In a first step of the protocol illustrated in FIG. 18A, entanglement sources 1010a and 1010b run until a heralding signal is detected at one of single photon detectors 1016a or 1016b, in this case single photon detector 1016b. Upon receipt of the heralding signal, the idler photon 1880b from entanglement source 1010b is directed to quantum buffer 1700, where it is stored. Signal photon 1882b is provided to quantum processing unit 1020e. While idler photon 1880a is stored at quantum buffer 1700, entanglement sources 1010a continues to run until a heralding signal is detected at single photon detector 1016a. This heralding signal may be provided to intermediate switch 1050 via a classical interconnect network, such as classical interconnect network 210 of FIG. 2.

Upon receipt of this second heralding signal, idler photon 1880b is released from quantum buffer 1700 to Bell state measurement device 1060, as illustrated in FIG. 18B. Idler photon 1880a from entanglement source 1010a is also provided to Bell state measurement device 1060, while signal photon 1082a is provided to quantum processing unit 1020a. Bell state measurement device 1060 measures idler photons 1880a and 1880b, creating entanglement between signal photons 1882a and 1882b, distributing entanglement between quantum processing units 1020a and 1020e.

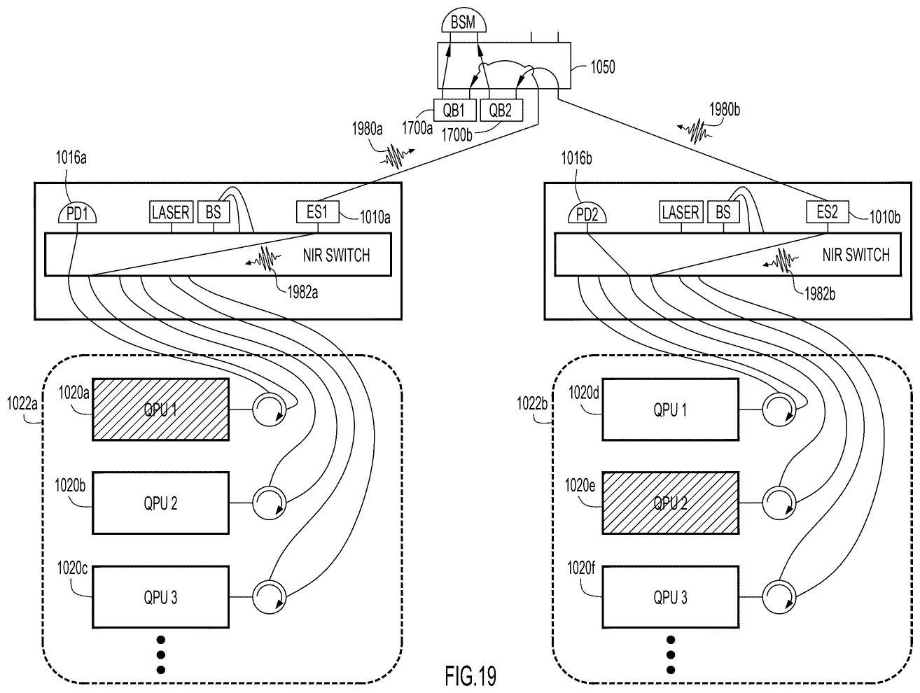

Turning to FIG. 19, depicted therein is a protocol for distributing entanglement between quantum processing units 1020a and 1020e using two quantum buffers. Accordingly, in the example of FIG. 19, intermediate switch 1050 is configured with quantum buffers 1700a and 1700b. In this example, entanglement sources 1010a and 1010b run until a heralding signal is detected at either of single photon detectors 1016a or 1016b. These heralding signals may be provided to intermediate switch 1050 via a classical interconnect network, such as classical interconnect network 210 of FIG. 2.

When the heralding signal is detected at single photon detector 1016a, idler photon 1980a is provided to quantum buffer 1700a and signal photon 1982a is provided to quantum processing unit 1020a. When the heralding signal is detected at single photon detector 1016b, idler photon 1980b is provided to quantum buffer 1700b and signal photon 1982b is provided to quantum processing unit 1020e. Once each of quantum buffers 1700a and 1700b is storing an idler photon, the quantum buffers 1700a and 1700b release their idler photons 1980a and 1980b to Bell state measurement device 1060. Bell state measurement device 1060 measures idler photons 1980a and 1980b, creating entanglement between signal photons 1982a and 1982b, distributing entanglement between quantum processing units 1020a and 1020e. Also, according to the protocol of FIG. 19 and unlike those of FIGS. 18A and 18B, there is no need for back-and-forth switching to quantum processing units upon receiving the heralding signal from the detector.

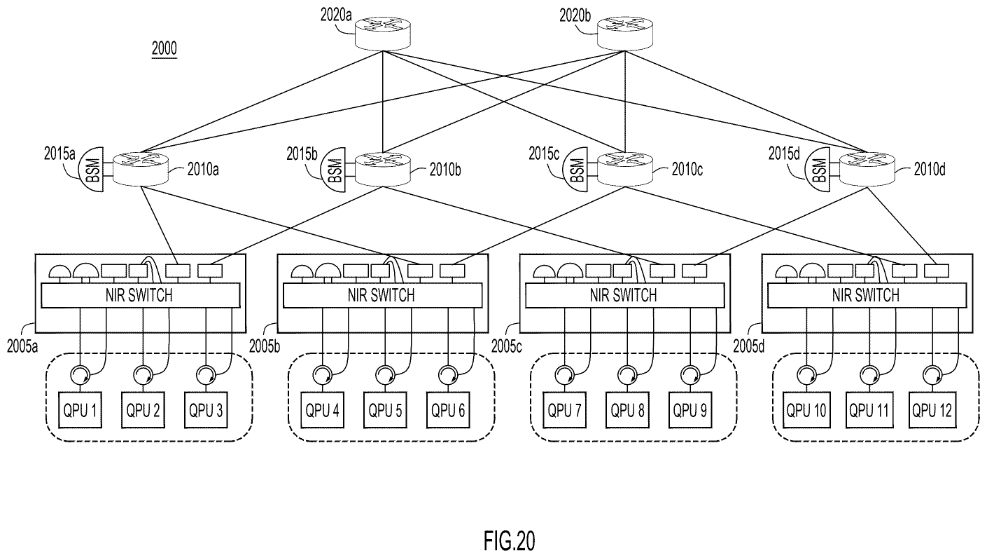

Each of the above-described quantum entanglement distribution protocols may be chained together to distribute entanglement throughout a network, as will now be described with reference to FIGS. 20-23. Illustrated in FIG. 20 is a Clos network 2000 similar in construction to Clos network 500 of FIG. 5. Accordingly, Clos network 2000 includes a plurality of quantum ToR switches 2005a, 2005b, 2005c and 2005d which serve as the input/output stage of Clos network 2000. The middle stage includes switches 2010a, 2010b, 2010c, and 2010d, each of which includes a respective Bell state measurement device 2015a, 2015b, 2015c, and 2015d, and switches 2020a and 2020b which interconnect switches 2010a-d.

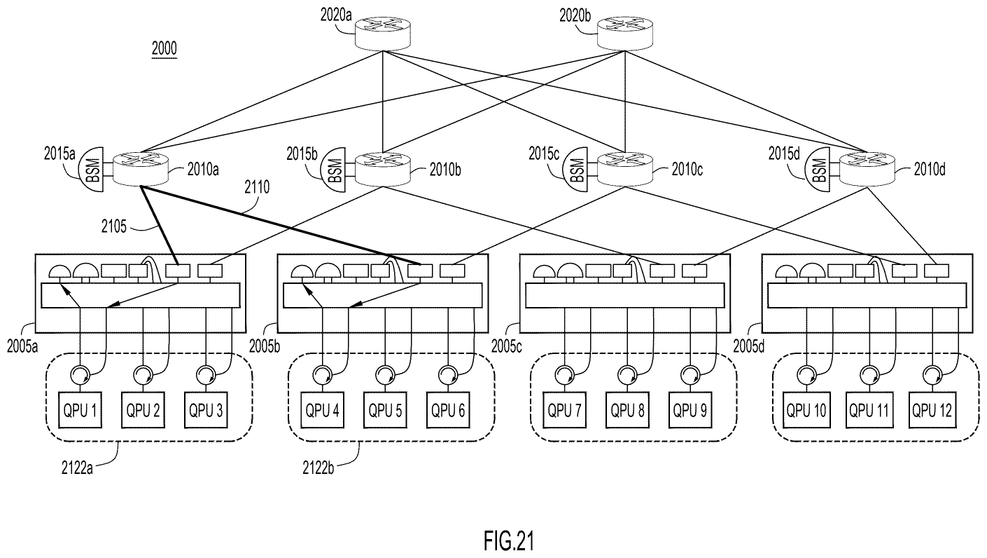

According to a first example, if entanglement is to be generated between two quantum processing units arranged on the same rack, a protocol as described above with reference to FIGS. 8A, 8B and 9 may be used. According to examples in which entanglement is to be generated between quantum processing units on different racks, a controller (not illustrated) arranged at one or more of switches 2005a-d, 2010a-d or 2020a/b, or another network device, such as data center orchestrator 205 of FIG. 2, creates paths between network devices through which entanglement is to be generated. For example, if entanglement is to be generated between a quantum processing unit arranged on the rack 2122a associated with ToR switch 2005a and rack 2122b associated with ToR switch 2005b, as illustrated in FIG. 21, the controller will create paths 2105 and 2110 through Clos network 2000 that allow ToR switches 2005a and 2005b to implement one of the inter-rack entanglement generation protocols described above with reference to one or more of FIGS. 9, 10, 15, 16, 18A, 18B and/or 19. The controller then sends commands to ToR switches 2005a and 2005b to implement the appropriate entanglement generation protocol. Similar network paths may be used to generate entanglement between any two quantum processing units arranged on racks serviced by ToR switches that connect to the same intermediate switch 2010a-d.

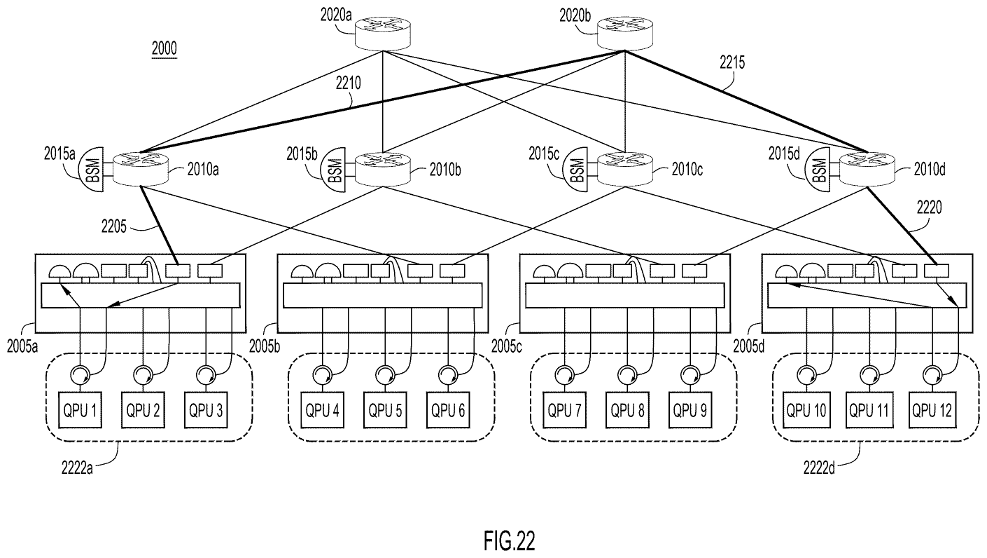

However, as illustrated in FIG. 22, there may be instances where entanglement is generated between quantum processing units arranged on racks serviced by ToR switches that do not connect to the same intermediate switch 2010a-d. For example, if entanglement is to be generated between a quantum processing unit arranged on rack 2222a associated with ToR switch 2005a and a quantum processing unit arranged on rack 2222d associated with ToR switch 2005d, there is no intermediate switch 2010a-d to which both ToR switch 2005a and ToR switch 2005d directly connect. In such situations, the controller will create a connection through Clos network 2000 using switches 2020a or 2020b to facilitate the entanglement generation. As illustrated in FIG. 22, the controller configures ToR switch 2005a to connect to switch 2010a via path 2205. Switch 2010a connects to switch 2020b via path 2210, which connects to switch 2010d via path 2215. ToR switch 2005d connects to intermediate switch 2010d via path 2220. According to this example, Bell state measurement device 2015d of intermediate switch 2010d performs the measurement of the idler photons provided by the quantum processing units. According to other examples, Bell state measurement device 2015a of intermediate switch 2010a may be used as it is also along the path between ToR switch 2005a and ToR switch 2005d.

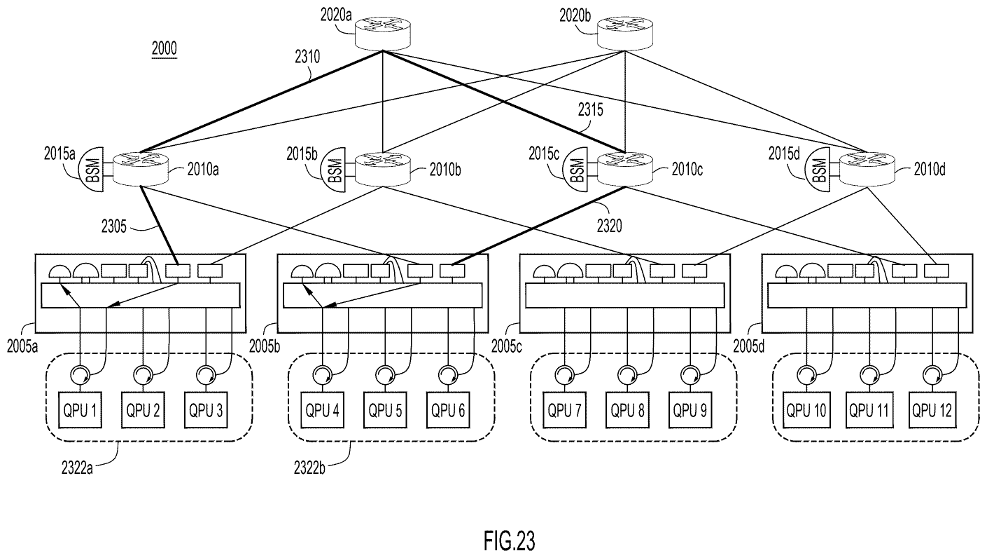

As described above, switches 2020a and 2020b may be used in instances where the ToR switches servicing the quantum processing units are not connected to the same intermediate switch 2010a-d. However, there may be situations in which switches 2020a and 2020b are used to distribute entanglement between two quantum processing units that are directly connected through the same intermediate switch 2010a-d. For example, if the Bell state measurement device is already leveraged by other quantum processing units, a Bell state measurement device arranged at another intermediate switch may be used, as illustrated in FIG. 23. As illustrated in FIG. 23, entanglement is to be distributed between a quantum processing unit arranged on rack 2322a and a quantum processing unit arranged on rack 2322b. Entanglement is distributed via network paths 2305, 2310, 2315 and 2320 using Bell state measurement device 2015c of intermediate switch 2010c. Bell state measurement device 2015c of intermediate switch 2010c is used even though ToR switch 2005a and ToR switch 2005b are both directly connected to intermediate switch 2010a.

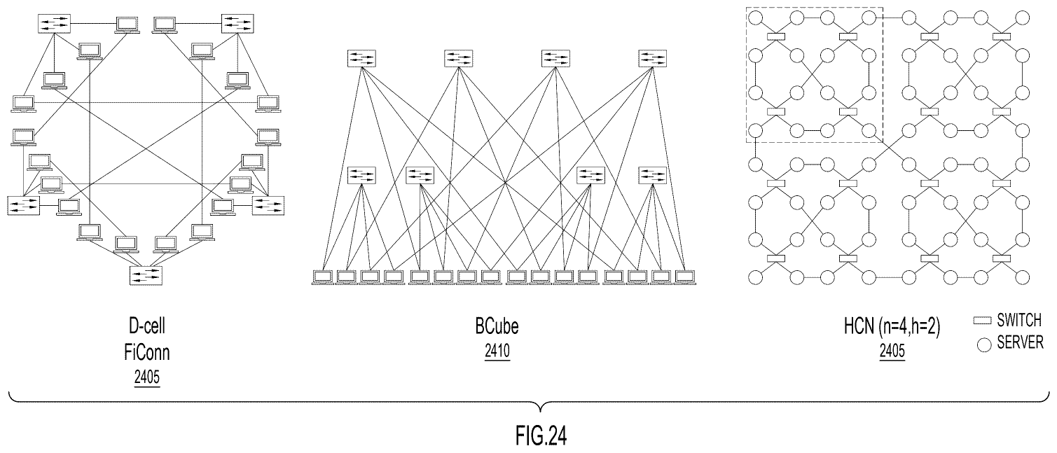

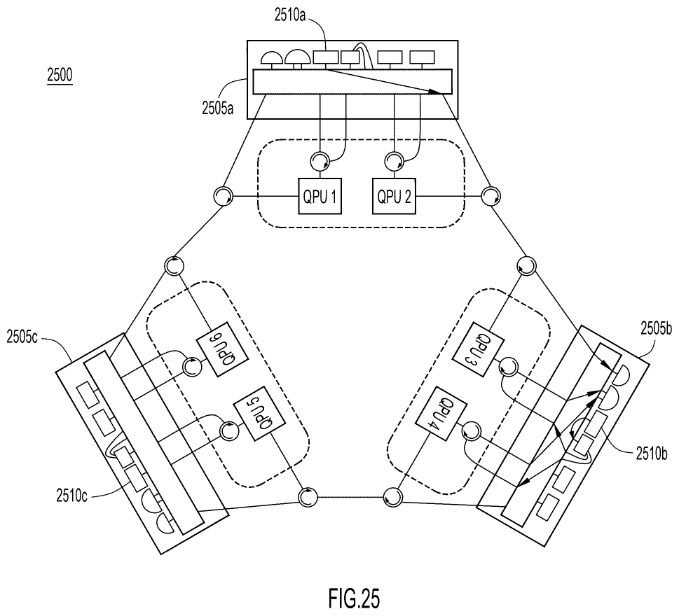

The above-described entanglement protocols are described with reference to Clos networks. The techniques may also be applied to different types of networks, as illustrated in FIG. 24. For example, the techniques may be applied to server-centric networks, such as D-Cell Fibonacci Connection (FiConn) network 2405, BCube network 2410, and/or Hybrid Cube network (HCN) 2415. For example, illustrated in FIG. 25 is a simple D-Cell network 2500 that includes three ToR switches 2505a, 2505b and 2505c, each of which has a respective Bell state measurement device 2510a, 2510b and 2510c. A D-Cell network is a type of data center network architecture designed to improve scalability, fault tolerance, and performance for large-scale computing. It differs from traditional hierarchical network designs (such as tree or fat-tree architectures) by using a recursive and self-similar structure. In D-Cell network 2500, the ToR switches 2505a-c serve as the recursive, self-similar structure.

Each of ToR switches 2505a-c can provide entanglement swapping for the other two ToR switches using the protocols described above. In other words, ToR switch 2505c can perform entanglement swapping using Bell state measurement device 2510c to distribute entanglement between quantum processing units associated with ToR switches 2505a and 2505b. ToR switch 2505b can perform entanglement swapping using Bell state measurement device 2510b to distribute entanglement between quantum processing units associated with ToR switches 2505a and 2505c. Analogously, ToR switch 2505a can perform entanglement swapping using Bell state measurement device 2510a to distribute entanglement between quantum processing units associated with ToR switches 2505b and 2505c.

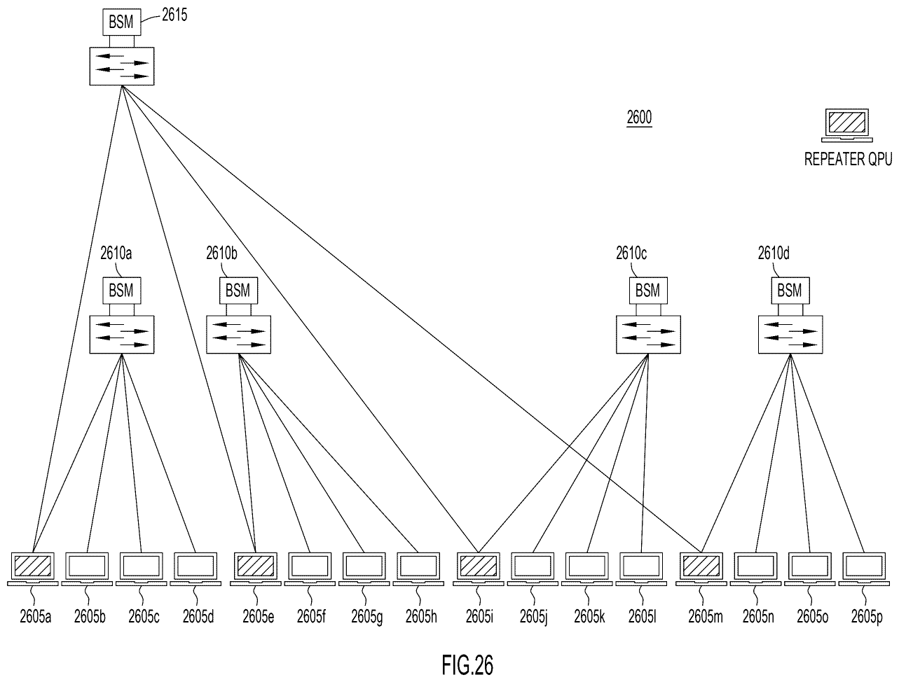

The techniques disclosed herein may also use quantum processing units arranged on racks associated with ToR switches as repeaters and to perform entanglement swapping. This use of the quantum processing units may decrease the number of switches in a particular quantum network environment. Illustrated in FIG. 26 is an abstract illustration of a partial BCube quantum network 2600 that includes quantum switches 2610a, 2610b, 2610c, and 2610d and 2615, in which some of the quantum processing units 2605a, 2605b, 2605c, 2605d, 2605e, 2605f, 2605g, 2605h, 2605i, 2605j, 2605k, 2605l, 2605m, 2605n, 2605o, and 2605p associated with ToR switches 2610a-d, specifically quantum processing units 2605a, 2605e, 2605i and 2605m, act as repeaters. This allows quantum network 2600 to be constructed using fewer intermediate switches 2615.

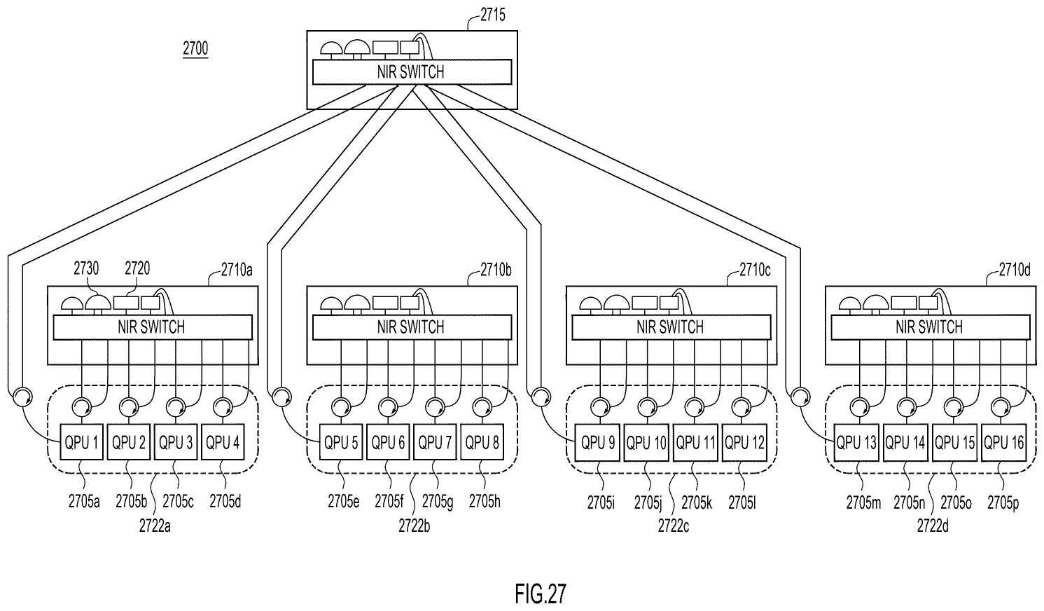

For example, illustrated in FIG. 27 is a network 2700. Network 2700 includes quantum processing units 2705a, 2705b, 2705c, 2705d, 2705e, 2705f, 2705g, 2705h, 2705i, 2705j, 2705k, 2705l, 2705m, 2705n, 2705o and 2705p arranged on the racks 2722a, 2722b, 2722c and 2722d of ToR switches 2710a, 2710b, 2710c and 2710d, respectively. To distribute entanglement between quantum processing units arranged on different racks 2722a-d, certain quantum processing units may be used as repeaters. For example, to distribute entanglement between quantum processing unit 2705b and quantum processing unit 2705k, quantum processing units 2705a and 2705i may be used as repeaters. Specifically, ToR switch 2710a may be configured to perform ebit generation between quantum processing units 2705a and 2705b. ToR switch 2710c may be configured to perform ebit generation between quantum processing units 2705i and 2705k. Intermediate switch 2715 may be configured to perform ebit generation between quantum processing units 2705a and 2705i. A Bell state measurement swap may then be performed at quantum processing units 2705a and 2705i to generate entanglement between quantum processing units 2705b and 2705k. In such a procedure, quantum processing units 2705a and 2705i serve as repeaters in the distribution of entanglement between quantum processing units 2705b and 2705k.

Entanglement may also be distributed between quantum processing units arranged on the same rack. For example, switch 2710a may be configured such that the inputs of quantum processing units 2705b and 2705c are connected to laser source 2720, and the outputs of quantum processing units 2705b and 2705c are connected to Bell state measurement device 2730. The intra-rack protocol of FIG. 8A or 8B may then be performed to distribute entanglement between quantum processing units 2705b and.

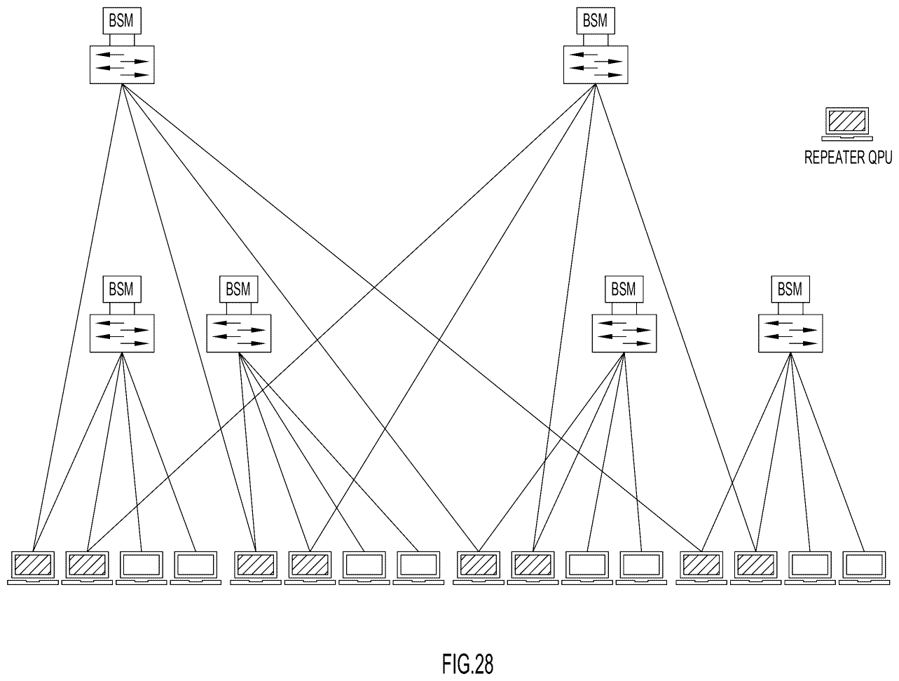

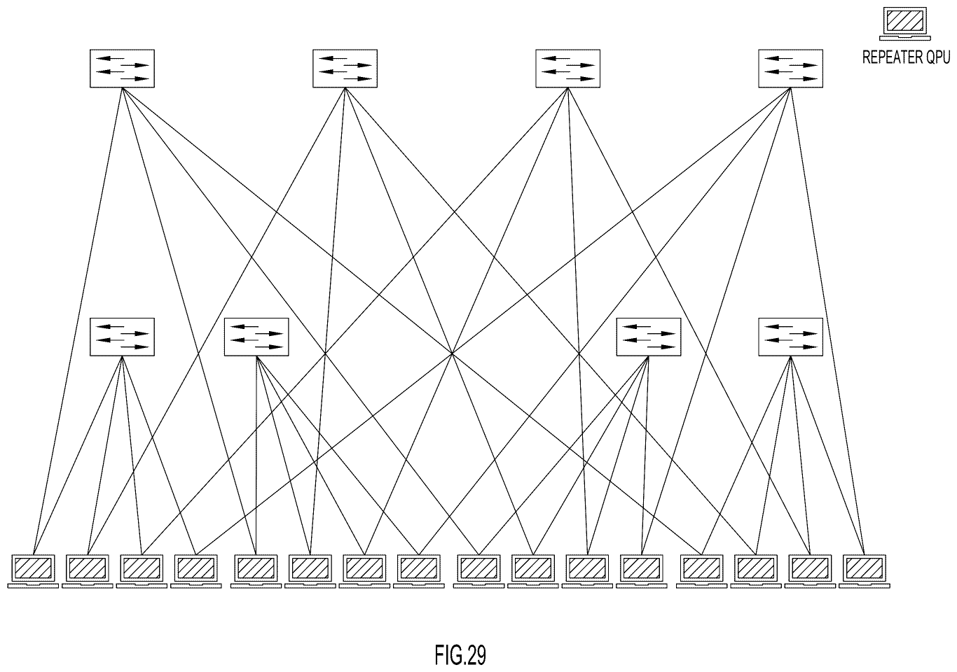

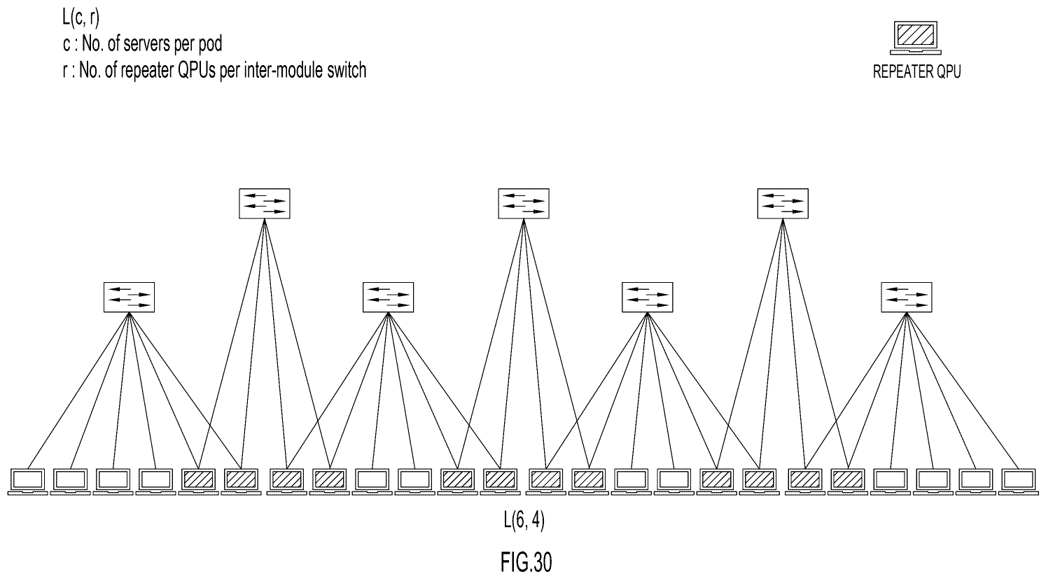

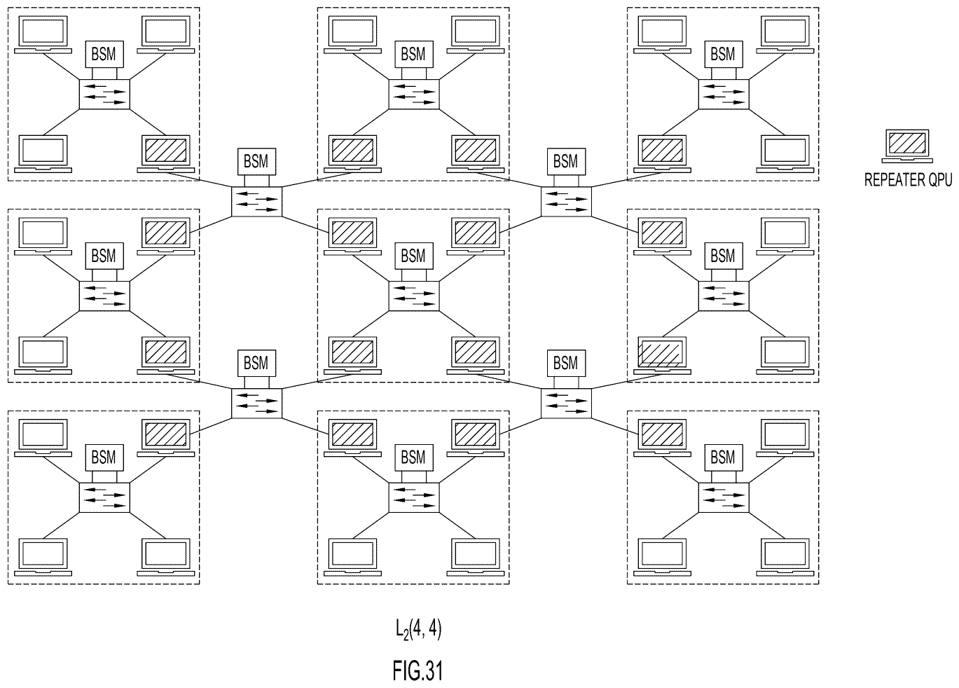

Analogous techniques to those described with reference to the partial BCube network of FIGS. 26 and 27 may be applied to more complicated BCube networks (as illustrated in FIG. 28), full BCube networks (as illustrated in FIG. 29), Linear networks (as illustrated in FIG. 30), and two-dimensional networks (as illustrated in FIG. 31), among others.

The disclosed techniques may also be used to execute quantum gates remotely between multiple quantum processing units in parallel as part of executing a quantum circuit in a distributed manner, i.e., a distributed quantum computing task. Ebit generation may be a relatively slow process, and therefore, it may be beneficial to parallelize the generation process as much as possible. Parallelizing remote gate execution in a quantum circuit disclosed herein includes two steps: 1. circuit decomposition, and 2. parallel execution.

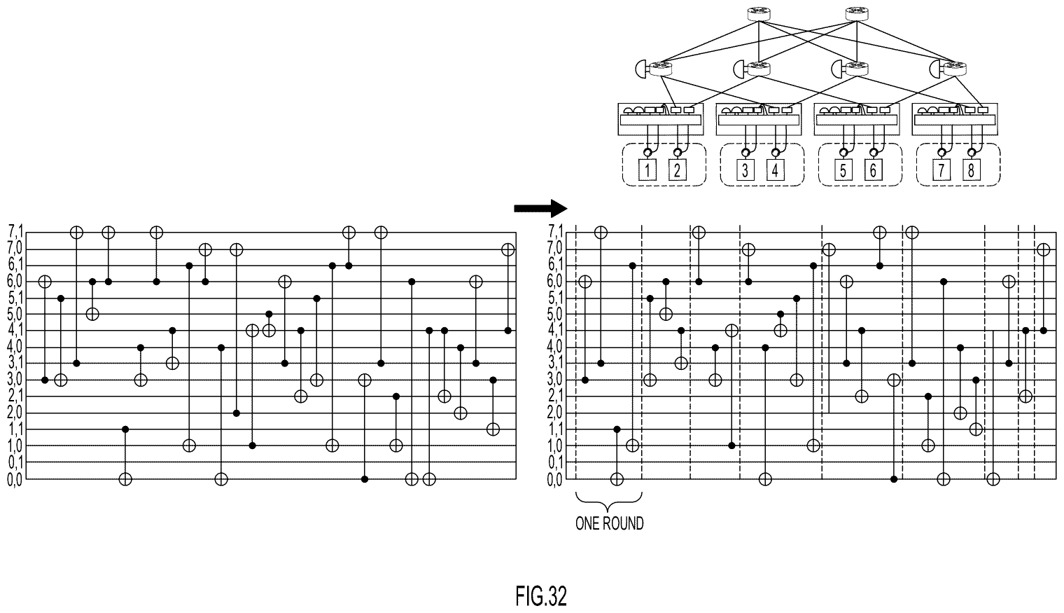

In the circuit decomposition step, an example of which is illustrated in FIG. 32, the process breaks a given quantum circuit (as a quantum task to be executed by a quantum data center) to several rounds of sequential execution that attempts to maximize the number of remote gates per round. Within each round, the gates do not interfere with each other and can potentially be executed in parallel. However, different rounds need to be executed sequentially according to their order. Each round of execution is characterized by the following properties: 1. there is only one two-qubit gate per qubit, and 2. as a result of property1, the two-qubit gates within each round commute and can be combined to be executed in parallel. In the parallel execution step of each round, the number of switching events necessary to deliver entanglement to all links is calculated, and each switching event is optimized to maximize the number of links to be generated in parallel. Depending on the network topology and resources available (e.g., the number of Bell state measurement devices available), there may be path blocking or resource contention for generating some links simultaneously. As a result, multiple switching events may be involved to execute the remote gates within one round.

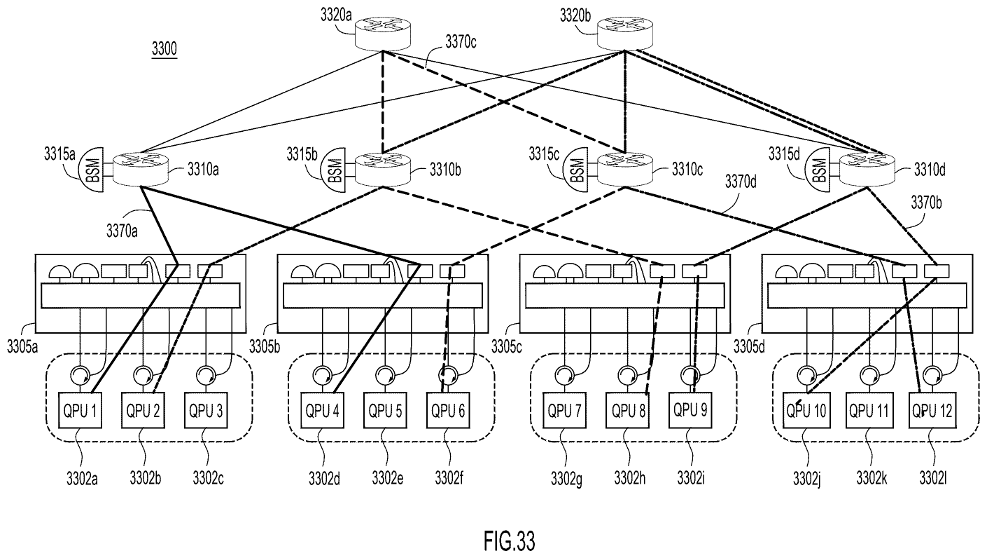

Consider the example of Clos network 3300 of FIG. 33 in which entanglement is to be distributed between quantum processing units 3302a, 3302b, 3302c, 3302d, 3302e, 3302f, 3302g, 3302h, 3302i, 3302j, 3302k and 3302l. According to the specific example of FIG. 33, entanglement is to be distributed to quantum processing unit 3302a and quantum processing unit 3302d using network path 3370a, between quantum processing unit 3302b and quantum processing unit 3302j using network path 3370b, between quantum processing unit 3302f and quantum processing unit 3302h using network path 3370c, and between quantum processing unit 3302i and quantum processing unit 3302l using network path 3370d.

This entanglement may be distributed in two rounds, with the first round distributing the entanglement between quantum processing unit 3302a and quantum processing unit 3302d, between quantum processing unit 3302b and quantum processing unit 3302j, and between quantum processing unit 3302f and quantum processing unit 3302h. The second round distributes the entanglement between quantum processing unit 3302i and quantum processing unit 3302l. The reason this distribution takes place in two rounds is because all paths connecting quantum processing unit 3302i and quantum processing unit 3302l are blocked. Specifically, each potential path between quantum processing unit 3302i and quantum processing unit 3302l includes at least one network link that is already being used in the first round of entanglement distribution. For example, as illustrated in FIG. 33, the network path 3370d between quantum processing unit 3302i and quantum processing unit 3302l utilizes the network link between switches 3320b and 3310d, which is also part of the network path 3370b used to distribute entanglement between quantum processing unit 3302b and quantum processing unit 3302j. Accordingly, a controller will create the necessary paths through Clos network 3300 between ToR switches 3305a, 3305b, 3305c and 3305d using switches 3310a, 3310b, 3310c, 3310d, 3320a and 3320b, and cause Bell state measurement devices 3315a, 3315b, 3315c and 3315d to implement the necessary measurements to distribute the entanglement in two rounds.

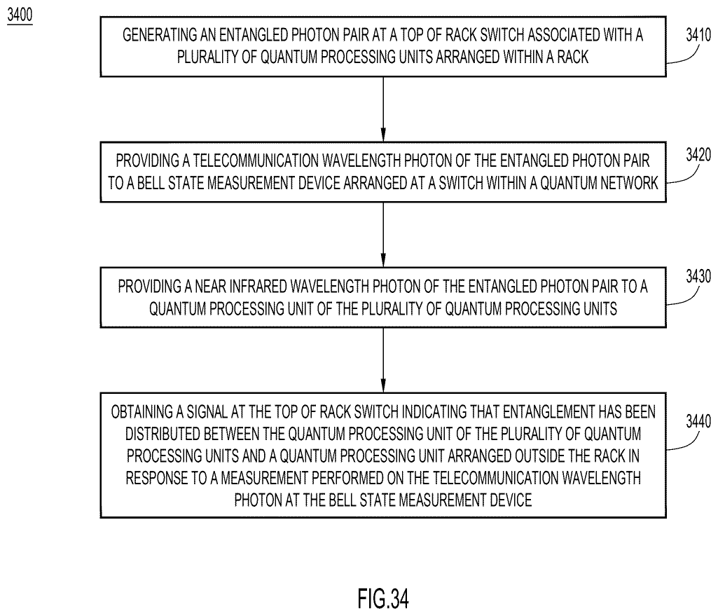

Turning to FIG. 34, depicted therein is a flowchart 3400 that provides a generalized example of a method of the disclosed techniques for generating entanglement between two quantum processing units arranged within a quantum network. At step 3410, an entangled photon pair is generated at a top-of-rack switch associated with a plurality of quantum processing units arranged within a rack. Next, in operation 3420, a telecommunication wavelength photon of the entangled photon pair is provided to a Bell state measurement device arranged at a switch within a quantum network.

In operation 3430, a near infrared wavelength photon of the entangled photon pair is provided to a quantum processing unit of the plurality of quantum processing units. And finally, in operation 3440, a signal is obtained at the top-of-rack switch indicating that entanglement has been distributed between the quantum processing unit of the plurality of quantum processing units and a quantum processing unit arranged outside the rack in response to a measurement performed on the telecommunication wavelength photon at the Bell state measurement device.

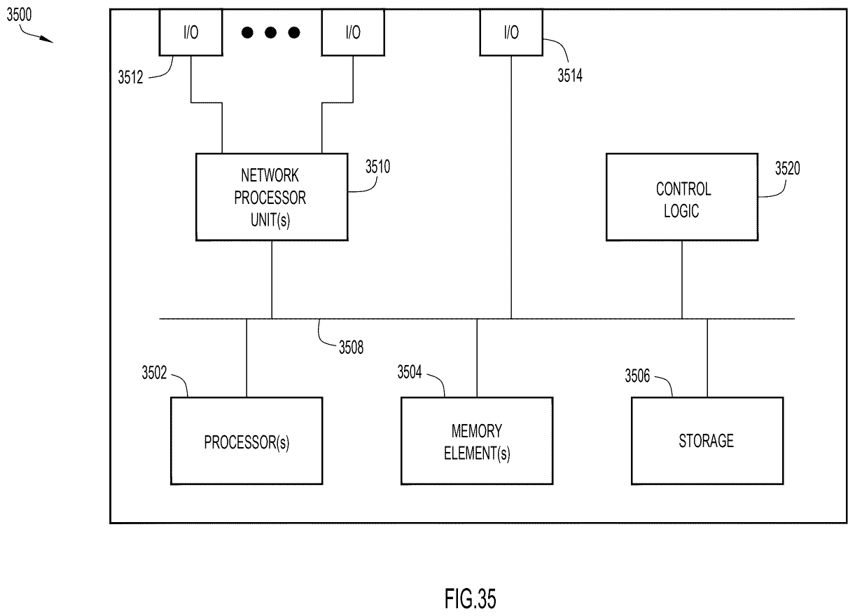

Referring to FIG. 35, FIG. 35 illustrates a hardware block diagram of a classical computing device 3500 used to implement the functions associated with operations discussed herein in connection with the techniques depicted in FIGS. 3-7, 8A, 8B, 9-16, 17A, 17B, 18A, 18B and 19-34. For example, the device may perform the operations described above with reference to the “controller” or “orchestrator,” or may implement classical aspects of FIG. 2, such as classical processors 225a-h, orchestrator 205 and/or classical interconnect network 210. The device 3500 may be a computer (laptop, desktop, etc.) or other device involved in video encoding/decoding operations, including video conference equipment, Smartphones, tablets, streaming servers, etc.

In at least one embodiment, the device 3500 may be any apparatus that may include one or more processor(s) 3502, one or more memory element(s) 3504, storage 3506, a bus 3508, one or more network processor unit(s) 3510 interconnected with one or more network input/output (I/O) interface(s) 3512, one or more I/O interface(s) 3514, and control logic 3520. I/O interfaces 3512 and 3514 may connect to the microphone, camera and display devices, including VR/AR headset described above. In various embodiments, instructions associated with logic for device 3500 can overlap in any manner and are not limited to the specific allocation of instructions and/or operations described herein.

In at least one embodiment, processor(s) 3502 is/are at least one hardware processor configured to execute various tasks, operations and/or functions for device 3500 as described herein according to software and/or instructions configured for device 3500. Processor(s) 3502 (e.g., a hardware processor) can execute any type of instructions associated with data to achieve the operations detailed herein. In one example, processor(s) 3502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 3504 and/or storage 3506 is/are configured to store data, information, software, and/or instructions associated with device 3500, and/or logic configured for memory element(s) 3504 and/or storage 3506. For example, any logic described herein (e.g., control logic 3520) can, in various embodiments, be stored for device 3500 using any combination of memory element(s) 3504 and/or storage 3506. Note that in some embodiments, storage 3506 can be consolidated with memory element(s) 3504 (or vice versa), or can overlap/exist in any other suitable manner.

In at least one embodiment, bus 3508 can be configured as an interface that enables one or more elements of device 3500 to communicate in order to exchange information and/or data. Bus 3508 can be implemented with any architecture designed for passing control, data and/or information between processors, memory elements/storage, peripheral devices, and/or any other hardware and/or software components that may be configured for device 3500. In at least one embodiment, bus 3508 may be implemented as a fast kernel-hosted interconnect, potentially using shared memory between processes (e.g., logic), which can enable efficient communication paths between the processes.

In various embodiments, network processor unit(s) 3510 may enable communication between device 3500 and other systems, entities, etc., via network I/O interface(s) 3512 (wired and/or wireless) to facilitate operations discussed for various embodiments described herein. In various embodiments, network processor unit(s) 3510 can be configured as a combination of hardware and/or software, such as one or more Ethernet driver(s) and/or controller(s) or interface cards, Fibre Channel (e.g., optical) driver(s) and/or controller(s), wireless /ceivers/ transmitters/transceivers, baseband processor(s)/modem(s), and/or other similar network interface driver(s) and/or controller(s) now known or hereafter developed to enable communications between device 3500 and other systems, entities, etc. to facilitate operations for various embodiments described herein. In various embodiments, network I/O interface(s) 3512 can be configured as one or more Ethernet port(s), Fibre Channel ports, any other I/O port(s), and/or antenna(s)/antenna array(s) now known or hereafter developed. Thus, the network processor unit(s) 3510 and/or network I/O interface(s) 3512 may include suitable interfaces for receiving, transmitting, and/or otherwise communicating data and/or information in a network environment. The hardware-based packet classification solution may be integrated into one or more ASICs that form a part or an entirety of the network processor unit(s) 3510.

I/O interface(s) 3514 allow for input and output of data and/or information with other entities that may be connected to device 3500. For example, I/O interface(s) 3514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, a VR/AR device, or the like.

In various embodiments, control logic 3520 can include instructions that, when executed, cause processor(s) 3502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 3520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 3504 and/or storage 3506 can store data, software, code, instructions (e.g., processor instructions), logic, parameters, combinations thereof, and/or the like used for operations described herein. This includes memory element(s) 3504 and/or storage 3506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In summary, the quantum switches, network topologies and entanglement generation protocols of FIGS. 2-7, 8A, 8B, 9-16, 17A, 17B, 18A, 18B and 19-34 may provide for the following:

### Architecture

Optical networks equipped with Bell state measurement devices and entanglement sources to connect quantum devices
Reconfigurable networks for connecting quantum computing devices
Architectures that allow reconfiguration of computing interconnect topology per algorithm or per sub-routing of an algorithm
Architectures that allow sharing of Bell state measurement devices and entanglement sources between computing nodes on-demand
Architectures that allow concurrent execution of multiple quantum algorithms (i.e., architectures capable of multi-tenancy)
Networks and data centers that support heterogeneous quantum computing technology
Architectures composed of co-existing and coordinated classical networks and quantum networks for quantum computing interconnection
Modular and scalable quantum architectures

### Routing and Scheduling of Quantum Channels

The creation of logical/virtual quantum computing interconnect topologies per algorithm or subroutine
Multiple co-existing and independent virtual/logical quantum networks

### Protocols for Generating End-to-End Entanglement

Protocols supporting change of topology in the network, i.e., reconfigurable quantum network interconnection
Protocols sharing Bell state measurement devices and entanglement sources between computing nodes
Protocols compensating for distance, delay and loss variation in a dynamically switched interconnect topology

### E2e Entanglement Generation, Swapping and Detection Across the Network

Sources and detectors that are shared (not fixed per node)

Accordingly, in some aspects, the techniques described herein relate to an apparatus including: a plurality of quantum processing units arranged within a rack; and a top-of-rack switch configured to: interconnect the plurality of quantum processing units using a near infrared optical link, and connect to a quantum network switch using a telecommunication wavelength link.

In some aspects, the techniques described herein relate to an apparatus, wherein the top-of-rack switch is configured to switch optical signals between the plurality of quantum processing units.

In some aspects, the techniques described herein relate to an apparatus, wherein the top-of-rack switch is configured to switch optical signals between the plurality of quantum processing units and a quantum networking device incorporated into the top-of-rack switch.

In some aspects, the techniques described herein relate to an apparatus, wherein the quantum networking device includes: a Bell state measurement device; a laser source; a single photon detector; a quantum frequency converter; a beam splitter; or an entanglement source.

In some aspects, the techniques described herein relate to an apparatus, wherein the top-of-rack switch is configured to interconnect a quantum processing unit of the plurality of quantum processing units to two or more quantum networking devices incorporated into the top-of-rack switch.

In some aspects, the techniques described herein relate to an apparatus, wherein each of the plurality of quantum processing units includes a respective communication qubit.

In some aspects, the techniques described herein relate to an apparatus, wherein the top-of-rack switch is configured to drive each of the respective communication qubits via a laser incorporated into the top-of-rack switch.

In some aspects, the techniques described herein relate to a system including: a first top-of-rack switch configured to interconnect a first plurality of quantum processing units arranged within a first rack using a first near infrared optical link; a second top-of-rack switch configured to interconnect a second plurality of quantum processing units arranged within a second rack using a second near infrared optical link; and a telecommunication wavelength network link forming a quantum network between the first top-of-rack switch and the second top-of-rack switch.

In some aspects, the techniques described herein relate to a system, further including a Bell state measurement device.

In some aspects, the techniques described herein relate to a system, wherein the Bell state measurement device is incorporated into the first top-of-rack switch or the second top-of-rack switch.

In some aspects, the techniques described herein relate to a system, wherein the Bell state measurement device is incorporated into a third switch of the quantum network.

In some aspects, the techniques described herein relate to a system, wherein the Bell state measurement device is configured to distribute entanglement between a quantum processing unit arranged within the first rack and a quantum processing unit arranged within the second rack.

In some aspects, the techniques described herein relate to a system, wherein the Bell state measurement device is configured to distribute entanglement between a first quantum processing unit arranged within the first rack and a second quantum processing unit arranged within the first rack.

In some aspects, the techniques described herein relate to a system, wherein the first top-of-rack switch is configured to switch optical signals between the first plurality of quantum processing units and a quantum networking device incorporated into the first top-of-rack switch.

In some aspects, the techniques described herein relate to a method including: generating an entangled photon pair at a top-of-rack switch associated with a plurality of quantum processing units arranged within a rack; providing a telecommunication wavelength photon of the entangled photon pair to a Bell state measurement device arranged at a switch within a quantum network; providing a near infrared wavelength photon of the entangled photon pair to a quantum processing unit of the plurality of quantum processing units; and obtaining a signal at the top-of-rack switch indicating that entanglement has been distributed between the quantum processing unit of the plurality of quantum processing units and a quantum processing unit arranged outside the rack in response to a measurement performed on the telecommunication wavelength photon at the Bell state measurement device.

In some aspects, the techniques described herein relate to a method, wherein generating the entangled photon pair include generating the entangled photon pair via an entanglement source incorporated into the top-of-rack switch.

In some aspects, the techniques described herein relate to a method, wherein generating the entangled photon pair include generating the near infrared wavelength photon entangled a second near infrared wavelength photon and converting the second near infrared wavelength photon to the telecommunication wavelength photon via a quantum frequency converter incorporated into the top-of-rack switch.

In some aspects, the techniques described herein relate to a method, wherein the Bell state measurement device is arranged at a second top-of-rack switch associated with the quantum processing unit arranged outside the rack.

In some aspects, the techniques described herein relate to a method, wherein the Bell state measurement device is arranged at an intermediate switch of a Clos network.

In some aspects, the techniques described herein relate to a method, wherein providing the near infrared wavelength photon of the entangled photon pair to the quantum processing unit of the plurality of quantum processing units includes providing the near infrared wavelength photon to a communication qubit of the quantum processing unit of the plurality of quantum processing units.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

The above description is intended by way of example only.

What is claimed is:

1. An apparatus comprising:
a plurality of quantum processing units arranged within a rack; and
a top-of-rack switch configured to:
interconnect the plurality of quantum processing units using a near infrared optical link, and
connect to a quantum network switch using a telecommunication wavelength link.

2. The apparatus of claim 1, wherein the top-of-rack switch is configured to switch optical signals between the plurality of quantum processing units.

3. The apparatus of claim 1, wherein the top-of-rack switch is configured to switch optical signals between the plurality of quantum processing units and a quantum networking device incorporated into the top-of-rack switch.

4. The apparatus of claim 3, wherein the quantum networking device comprises:
a Bell state measurement device;
a laser source;
a single photon detector;
a quantum frequency converter;
a beam splitter; or an entanglement source.

5. The apparatus of claim 3, wherein the top-of-rack switch is configured to interconnect a quantum processing unit of the plurality of quantum processing units to two or more quantum networking devices incorporated into the top-of-rack switch.

6. The apparatus of claim 1, wherein each of the plurality of quantum processing units comprises a respective communication qubit.

7. The apparatus of claim 6, wherein the top-of-rack switch is configured to drive each of the respective communication qubits via a laser incorporated into the top-of-rack switch.

8. A system comprising:
a first top-of-rack switch configured to interconnect a first plurality of quantum processing units arranged within a first rack using a first near infrared optical link;
a second top-of-rack switch configured to interconnect a second plurality of quantum processing units arranged within a second rack using a second near infrared optical link; and
a telecommunication wavelength network link forming a quantum network between the first top-of-rack switch and the second top-of-rack switch.

9. The system of claim 8, further comprising a Bell state measurement device.

10. The system of claim 9, wherein the Bell state measurement device is incorporated into the first top-of-rack switch or the second top-of-rack switch.

11. The system of claim 9, wherein the Bell state measurement device is incorporated into a third switch of the quantum network.

12. The system of claim 9, wherein the Bell state measurement device is configured to distribute entanglement between a quantum processing unit arranged within the first rack and a quantum processing unit arranged within the second rack.

13. The system of claim 9, wherein the Bell state measurement device is configured to distribute entanglement between a first quantum processing unit arranged within the first rack and a second quantum processing unit arranged within the first rack.

14. The system of claim 8, wherein the first top-of-rack switch is configured to switch optical signals between the first plurality of quantum processing units and a quantum networking device incorporated into the first top-of-rack switch.

15. A method comprising:
generating an entangled photon pair at a top-of-rack switch associated with a plurality of quantum processing units arranged within a rack;
providing a telecommunication wavelength photon of the entangled photon pair to a Bell state measurement device arranged at a switch within a quantum network;
providing a near infrared wavelength photon of the entangled photon pair to a quantum processing unit of the plurality of quantum processing units; and
obtaining a signal at the top-of-rack switch indicating that entanglement has been distributed between the quantum processing unit of the plurality of quantum processing units and a quantum processing unit arranged outside the rack in response to a measurement performed on the telecommunication wavelength photon at the Bell state measurement device.

16. The method of claim 15, wherein generating the entangled photon pair comprise generating the entangled photon pair via an entanglement source incorporated into the top-of-rack switch.

17. The method of claim 15, wherein generating the entangled photon pair comprise generating the near infrared wavelength photon entangled a second near infrared wavelength photon and converting the second near infrared wavelength photon to the telecommunication wavelength photon via a quantum frequency converter incorporated into the top-of-rack switch.

18. The method of claim 15, wherein the Bell state measurement device is arranged at a second top-of-rack switch associated with the quantum processing unit arranged outside the rack.

19. The method of claim 15, wherein the Bell state measurement device is arranged at an intermediate switch of a Clos network.

20. The method of claim 15, wherein providing the near infrared wavelength photon of the entangled photon pair to the quantum processing unit of the plurality of quantum processing units comprises providing the near infrared wavelength photon to a communication qubit of the quantum processing unit of the plurality of quantum processing units.
